(19) United States
(12) Patent Application Publication
(10) Pub. No.: US 2025/0338290 A1
(43) Pub. Date: Oct. 30, 2025

(54) REDUCED BLIND DECODING FOR DOWNLINK CONTROL IN WIRELESS SYSTEMS

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Emad Nader Farag, Flanders, NJ (US)

(21) Appl. No.: 19/174,853

(22) Filed: Apr. 9, 2025

Related U.S. Application Data
(60) Provisional application No. 63/638,344, filed on Apr. 24, 2024.

(51) Int. Cl. H04W 72/232; H04L 5/00; H04W 24/08

(52) U.S. Cl. CPC H04W 72/232; H04L 5/0053; H04W 24/08

(57) ABSTRACT

Methods and apparatuses for reduced blind decoding for downlink control. A method for a user equipment (UE) includes receiving first information for a first control resource set (CORESET) and receiving a first physical downlink control channel (PDCCH) in a CORESET. The reception of the PDCCH is in a first slot or a first PDCCH monitoring occasion (MO). The first PDCCH provides a first downlink control information (DCI) format. The first DCI format includes PDCCH assistance information (PAI) associated with a second PDCCH in a second slot or a second PDCCH MO. The CORESET is the first CORESET or a second CORESET. The method further includes determining, based on the PAI, second one or more PDCCH candidates within the first CORESET and monitoring the second PDCCH in the second one or more PDCCH candidates and the second slot or the second PDCCH MO.

### CROSS-REFERENCE TO RELATED AND CLAIM OF PRIORITY

The present application claims priority under 35 U.S.C. § 119 (e) to U.S. Provisional Patent Application No. 63/638,344 filed on Apr. 24, 2024, which is hereby incorporated by reference in its entirety.

### TECHNICAL FIELD

The present disclosure relates generally to wireless communication systems and, more specifically, the present disclosure relates to methods and apparatuses for reduced blind decoding for downlink control.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to reduced blind decoding for downlink control.

In one embodiment, a method for a user equipment (UE) is provided. The method includes receiving first information for a first control resource set (CORESET) and receiving a first physical downlink control channel (PDCCH) in a CORESET. The reception of the PDCCH is in a first slot or a first PDCCH monitoring occasion (MO). The first PDCCH provides a first downlink control information (DCI) format. The first DCI format includes PDCCH assistance information (PAI) associated with a second PDCCH in a second slot or a second PDCCH MO. The CORESET is the first CORESET or a second CORESET. The method further includes determining, based on the PAI, second one or more PDCCH candidates within the first CORESET and monitoring the second PDCCH in the second one or more PDCCH candidates and the second slot or the second PDCCH MO.

In another embodiment, UE is provided. The UE includes a transceiver configured to receive first information for a first CORESET and receive a first PDCCH in a CORESET. The reception of the PDCCH is in a first slot or a first PDCCH MO. The first PDCCH provides a first DCI format. The first DCI format includes PAI associated with a second PDCCH in a second slot or a second PDCCH MO. The CORESET is the first CORESET or a second CORESET. The UE further includes a processor operably coupled with the transceiver. The processor is configured to determine, based on the PAI, second one or more PDCCH candidates within the first CORESET. The transceiver is further configured to monitor the second PDCCH in the second one or more PDCCH candidates and the second slot or the second PDCCH MO.

In yet another embodiment, a base station is provided. The base station includes a transceiver configured to transmit first information for a first CORESET and transmit a first PDCCH, in a CORESET. The reception of the PDCCH is in a first slot or a first PDCCH MO. The first PDCCH provides a first DCI format. The first DCI format includes PAI associated with a second PDCCH in a second slot or a second PDCCH MO. The CORESET is the first CORESET or a second CORESET. The base station further includes a processor operably coupled with the transceiver. The processor is configured to determine, based on the PAI, second one or more PDCCH candidates within the first CORESET. The transceiver is further configured to transmit the second PDCCH in a PDCCH candidate from the second one or more PDCCH candidates and the second slot or the second PDCCH MO.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5 illustrates a flowchart of a method performed by UE according to embodiments of the present disclosure;

FIG. 6 illustrates a flowchart of a method of providing assistance-information for monitoring one or multiple subsequent PDCCHs; and

FIG. 7 illustrates a flowchart of a method for fallback from PDCCH monitoring based on assistance information to PDCCH monitoring with full blind decoding.

### DETAILED DESCRIPTION

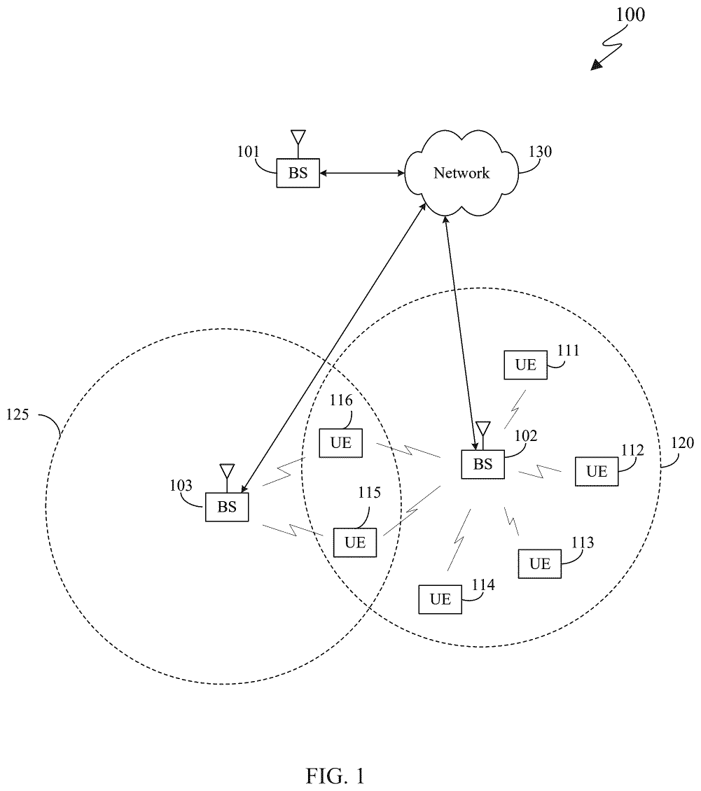

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 Rel-18 v18.1.0, “NR; Physical channels and modulation”; [REF2] 3GPP TS 38.212 Rel-18 v18.1.0, “NR; Multiplexing and channel coding”; [REF3] 3GPP TS 38.213 Rel-18 v18.1.0, “NR; Physical layer procedures for control”; [REF4] 3GPP TS 38.214 Rel-18 v18.1.0, “NR; Physical layer procedures for data”; [REF5] 3GPP TS 38.215 Rel-18 v18.1.0, “NR; Physical layer measurements”; [REF6] 3GPP TS 38.321 Rel-18 v18.0.0, “NR; Medium Access Control (MAC) protocol specification”; [REF7] 3GPP TS 38.331 Rel-18 v18.0.0, “NR; Radio Resource Control (RRC) protocol specification”; [REF8] 3GPP TS 38.300 Rel-18 v18.0.0, “NR; NR and NG-RAN Overall Description; Stage 2”; [REF9] 3GPP TS 38.304 Rel-18 v18.0.0, “NR; User Equipment (UE) procedures in Idle mode and in RRC Inactive state”; [REF10] 3GPP TR 22.840 Rel-19 v19.0.0, “Study on Ambient power-enabled Internet of Things”; [REF11] 3GPP TR 38.848 Rel-18 v18.0.0, “Study on Ambient IoT (Internet of Things) in RAN”; [REF12] 3GPP TR 38.869 Rel-18 v18.0.0, “Study on low-power Wake-up Signal and Receiver for NR”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for reduced blind decoding for downlink control. In certain embodiments, one or more of the BSs 101-103 include circuitry, programing, or a combination thereof to support reduced blind decoding for downlink control.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

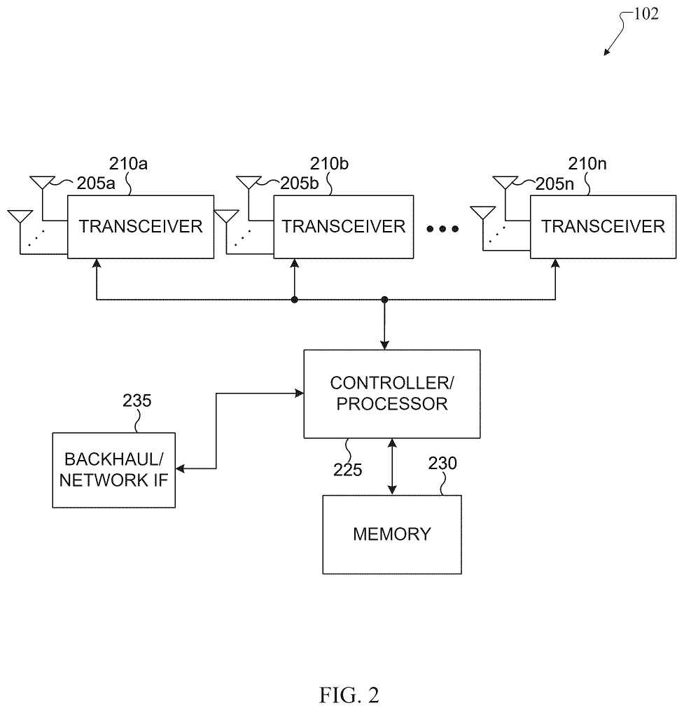

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting reduced blind decoding for downlink control. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

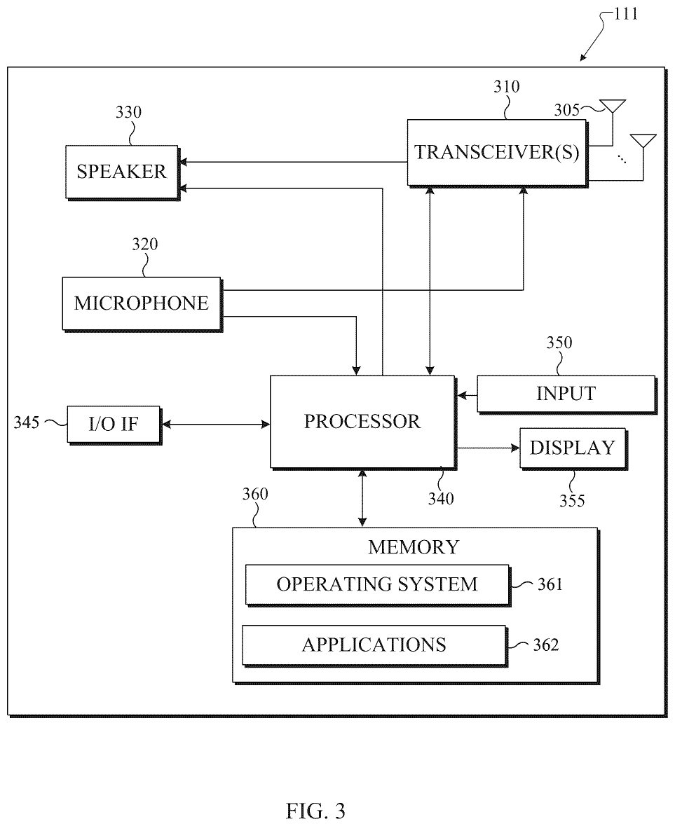

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for reduced blind decoding for downlink control as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

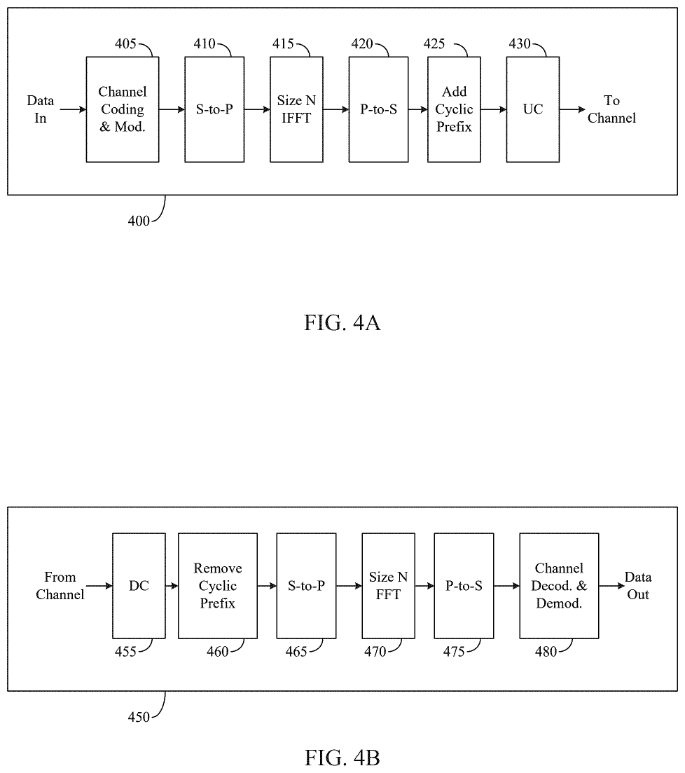

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to utilize reduced blind decoding for downlink control as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

In addition, 5G radio provides optimized support for additional services and features in 3GPP Release 16 such as vehicular (V2X) and device-to-device (D2D) communications, wireless backhauling (IAB), coordinated multi-point (COMP) or Multi-TRP transmission and reception (multi-TRP), cross-link interference (CLI) and remote interference (RIM) detection and avoidance, and NR operation in unlicensed bands (NR-U).

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes of NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (physical random access channel (PRACH) as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE 116 may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE 116 (such as the UE 116) may expect that synchronization signal (SS)/physical broadcast channel block (also denoted as SSBs) transmitted with the same block index on the same center frequency location are quasi co-located with respect to Doppler spread, Doppler shift, average gain, average delay, delay spread, and, when applicable, spatial Rx parameters. The UE 116 may not expect quasi co-location for any other synchronization signal SS/PBCH block transmissions.

In absence of CSI-RS configuration, and unless otherwise configured, the UE 116 may expect PDSCH DM-RS and SSB to be quasi co-located with respect to Doppler shift, Doppler spread, average delay, delay spread, and, when applicable, spatial Rx parameters. The UE 116 may expect that the PDSCH DM-RS within the same code division multiplexing (CDM) group is quasi co-located with respect to Doppler shift, Doppler spread, average delay, delay spread, and spatial Rx. The UE 116 may also expect that DM-RS ports associated with a PDSCH are QCL with QCL type A, type D (when applicable) and average gain. The UE 116 may further expect that no DM-RS collides with the SS/PBCH block.

The UE 116 can be configured with a list of up to M transmission configuration indication (TCI) State configurations within the higher layer parameter PDSCH-Config to decode PDSCH according to a detected PDCCH with DCI intended for the UE 116 and the given serving cell, where M depends on the UE 116 capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE 116 receives a MAC-control element (CE) activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to typical 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by master information block (MIB) or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an information element (IE) ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or SCG. A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The time locations of SSBs within a half-frame are determined by sub-carrier spacing and the periodicity of the half-frames where SSBs are transmitted is configured by the network (e.g., the network 130). During a half-frame, different SSBs may be transmitted in different spatial directions (i.e., using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with an remaining minimum system information (RMSI), the SSB is referred to as a Cell-Defining SSB (CD-SSB). A primary cell (PCell) is associated to a CD-SSB located on the synchronization raster.

Polar coding is used for PBCH. The UE may expect a band-specific sub-carrier spacing for the SSB unless a network has configured the UE to expect a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to all groups of resource blocks belonging to the same L2 PDU scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
MIB contains cell barred status information and essential physical layer information of the cell required to receive further system information, e.g. CORESET #0 configuration. MIB is periodically broadcast on BCH.
SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.

Other SI (OSI) encompasses all SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC INACTIVE state through Paging messages, and to notify UEs in RRC_IDLE, RRC_INACTIVE and RRC_CONNECTED state of system information change and ETWS/CMAS indications through Short Messages. Both Paging messages and Short Messages are addressed with P-RNTI on PDCCH, but while the former is sent on PCCH, the latter is sent over PDCCH directly (see clause 6.5 of TS 38.331).

For monitoring of a PDCCH candidate by a UE, if the UE:
has received ssb-PositionsInBurst in SIB1 and has not received ssb-PositionsInBurst in ServingCellConfigCommon for a serving cell, and
does not monitor PDCCH candidates in a Type0-PDCCH CSS set, and
at least one RE for a PDCCH candidate overlaps with at least one RE of a candidate SS/PBCH block, after puncturing if applicable, corresponding to a SS/PBCH block index provided by ssb-PositionsInBurst in SIB1,
   the UE is not required to monitor the PDCCH candidate.

For monitoring of a PDCCH candidate by a UE, if the UE:
has received ssb-PositionsInBurst in ServingCellConfigCommon for a serving cell, and
does not monitor PDCCH candidates in a Type0-PDCCH CSS set, and
at least one RE for a PDCCH candidate overlaps with at least one RE of a candidate SS/PBCH block, after puncturing if applicable, corresponding to a SS/PBCH block index provided by ssb-PositionsInBurst in ServingCellConfigCommon,
   the UE is not required to monitor the PDCCH candidate.

For monitoring of a PDCCH candidate by a UE, if the UE:
has received ssb-PositionsInBurst in SSB-MTCAdditionalPCI for a serving cell, and
at least one RE for a PDCCH candidate overlaps with at least one RE of a candidate SS/PBCH block, after puncturing if applicable, corresponding to a SS/PBCH block index provided by ssb-PositionsInBurst in SSB-MTCAdditionalPCI with same physical cell identity as the one associated with a RS having same quasi-collocation properties as a CORESET for the PDCCH candidate,
   the UE is not required to monitor the PDCCH candidate.

A UE is not required to monitor PDCCH candidates for a Type0/0A/0B/1/1A/2/2A-PDCCH CSS set when the active TCI state for a corresponding CORESET is not associated with physCellId in ServingCellConfigCommon.

If a UE monitors the PDCCH candidate for a Type0-PDCCH CSS set on the serving cell according to the procedure described in clause 13, the UE may assume that no SS/PBCH block is transmitted in REs used for monitoring the PDCCH candidate on the serving cell.

If at least one RE of a PDCCH candidate for a UE on the serving cell overlaps with at least one RE of lte-CRS-ToMatchAround or of LTE-CRS-PatternList, the UE:
is not required to monitor the PDCCH candidate if the UE is not provided pdcchCandidateReception-WithCRSOverlap,
monitors the PDCCH candidate if the UE is provided pdcchCandidateReception-WithCRSOverlap and the UE indicates an associated capability corresponding to the configuration of lte-CRS-ToMatchAround or of LTE-CRS-PatternList [18, TS 38.306].

If a UE is provided availableRB-SetsPerCell, the UE is not required to monitor PDCCH candidates that overlap with any RB from RB sets that are indicated as unavailable for receptions by an available RB set indicator field in DCI format 2_0 as described in clause 11.1.1. If the UE does not obtain the available RB set indicator for a symbol, the UE monitors PDCCH candidates on all RB sets in the symbol.

If a UE can support:
a first set of

$${N}_{cells , 0}^{DL}$$

serving cells where the UE is either not provided coresetPoolIndex or is provided coresetPoolIndex with a single value for all CORESETs on all DL BWPs of each scheduling cell from the first set of serving cells, and
a second set of

$${N}_{cells , 1}^{DL}$$

serving cells where the UE is not provided coresetPoolIndex or is provided coresetPoolIndex with a value 0 for a first CORESET, and with a value 1 for a second CORESET on any DL BWP of each scheduling cell from the second set of serving cells,

the UE determines, for the purpose of reporting pdcch-BlindDetectionCA, pdcch-BlindDetectionCA1, and pdcch-BlindDetectionCA3, a number of serving cells as

$${N}_{cells , 0}^{DL} + R \cdot {N}_{cells , 1}^{DL}$$

where R is a value reported by the UE.

If a UE indicates in UE-NR-Capability a carrier aggregation capability larger than 4 serving cells and the UE is not provided monitoringCapabilityConfig for any downlink cell or if the UE is provided monitoringCapabilityConfig=r15monitoringcapability for all downlink cells where the UE monitors PDCCH, the UE includes in UE-NR-Capability an indication for a maximum number of PDCCH candidates and for a maximum number of non-overlapped CCEs the UE can monitor per slot when the UE is configured for carrier aggregation operation over more than 4 cells. When a UE is not configured for NR-DC operation, the UE determines a capability to monitor a maximum number of PDCCH candidates and a maximum number of non-overlapped CCEs per slot that corresponds to

$${N}_{cells}^{cap}$$

downlink cells, where:

$${N}_{cells}^{cap}$$

is

$${N}_{cells , 0}^{DL} + R \cdot {N}_{cells , 1}^{DL}$$

if the UE does not provide pdcch-BlindDetectionCA where

$${N}_{cells , 0}^{DL} + {N}_{cells , 1}^{DL}$$

is the number of configured downlink serving cells,
otherwise,

$${N}_{cells}^{cap}$$

is the value of pdcch-BlindDetectionCA.

When a UE is configured for NR-DC operation, the UE determines a capability to monitor a maximum number of PDCCH candidates and a maximum number of non-overlapped CCEs per slot that corresponds to

$${N}_{cells}^{cap} = {N}_{cells}^{MCG}$$

downlink cells for the MCG where

$${N}_{cells}^{MCG}$$

is provided by pdcch-BlindDetection for the MCG and determines a capability to monitor a maximum number of PDCCH candidates and a maximum number of non-overlapped CCEs per slot that corresponds to

$${N}_{cells}^{cap} = {N}_{cells}^{SCG}$$

downlink cells for the SCG where

$${N}_{cells}^{SCG}$$

is provided by pdcch-BlindDetection for the SCG. When the UE is configured for carrier aggregation operation over more than 4 cells, or for a cell group when the UE is configured for NR-DC operation, the UE does not expect to monitor per slot a number of PDCCH candidates or a number of non-overlapped CCEs that is larger than the maximum number as derived from the corresponding value of

$${N}_{cells}^{cap} .$$

The following describes UE procedure for determining physical downlink control channel assignment.

A set of PDCCH candidates for a UE to monitor is defined in terms of PDCCH search space sets. A search space set can be a CSS set or a USS set. A UE monitors PDCCH candidates in one or more of the following search spaces sets:
a Type0-PDCCH CSS set on the primary cell of the MCG configured by:
   pdcch-ConfigSIB1 in MIB or by searchSpaceSIB1 in PDCCH-ConfigCommon or by searchSpaceZero in PDCCH-ConfigCommon for a DCI format 1_0 with CRC scrambled by a SI-RNTI, or
   searchSpaceZero by providing searchSpaceID=0 for searchSpaceMCCH or searchSpaceMTCH for a DCI format 4_0 with CRC scrambled by a MCCH-RNTI or a G-RNTI for broadcast, or
   searchSpaceZero by providing searchSpaceID-0 for searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for multicast in RRC_INACTIVE state,
a Type0A-PDCCH CSS set configured by searchSpaceOtherSystemInformation in PDCCH-ConfigCommon for a DCI format 1_0 with CRC scrambled by a SI-RNTI on the primary cell of the MCG,
a Type0B-PDCCH CSS set configured by:
   searchSpaceMCCH and searchSpaceMTCH for a DCI format 4_0 with CRC scrambled by a MCCH-RNTI or a G-RNTI for broadcast, on the primary cell of the MCG
   searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for PDCCH receptions in RRC_INACTIVE state,
a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell,
a Type1A-PDCCH CSS set configured by sdt-SearchSpace in PDCCH-ConfigCommon for a DCI format with CRC scrambled by a C-RNTI or a CS-RNTI on the primary cell as described in clause 19.1,
a Type2-PDCCH CSS set configured by pagingSearchSpace in PDCCH-ConfigCommon for a DCI format 1_0 with CRC scrambled by a P-RNTI on the primary cell of the MCG,
a Type2A-PDCCH CSS set configured by pei-SearchSpace in pei-ConfigBWP for a DCI format 2_7 with CRC scrambled by a PEI-RNTI on the primary cell of the MCG,
a Type3-PDCCH CSS set configured by:
   SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or cellDTRX-RNTI and, only for the primary cell, C-RNTI, MCS-C-RNTI, CS-RNTI(s), or PS-RNTI, or
   SearchSpace in pdcch-ConfigMulticast for DCI formats with CRC scrambled by G-RNTI, or G-CS-RNTI, or
   searchSpaceMCCH and searchSpaceMTCH on a secondary cell for a DCI format 4-0 with CRC scrambled by a MCCH-RNTI or a G-RNTI for broadcast, and
a USS set configured by
   SearchSpace in PDCCH-Config with searchSpace Type=ue-Specific for DCI formats with CRC scrambled by C-RNTI, MCS-C-RNTI, SP-CSI-RNTI, CS-RNTI(s), SL-RNTI, SL-CS-RNTI, SL Semi-Persistent Scheduling V-RNTI, or NCR-RNTI.

In the following, DCI formats with CRC scrambled by C-RNTI or CS-RNTI or MCS-C-RNTI are also referred to as unicast DCI formats, DCI formats with CRC scrambled by G-RNTI for multicast or G-CS-RNTI are also referred to as multicast DCI formats, and DCI formats with CRC scrambled by MCCH-RNTI or G-RNTI for broadcast scheduling PDSCH receptions are also referred to as broadcast DCI formats, and DCI formats with CRC scrambled by multicast-MCCH-RNTI or G-RNTI for multicast scheduling PDSCH receptions in RRC_INACTIVE state are also referred as multicast DCI formats for RRC_INACTIVE state.

For a DL BWP, if a UE is not provided searchSpaceSIBI for Type0-PDCCH CSS set by PDCCH-ConfigCommon, the UE does not monitor PDCCH candidates for a Type0-PDCCH CSS set on the DL BWP. The Type0-PDCCH CSS set is defined by the CCE aggregation levels and the number of PDCCH candidates per CCE aggregation level given in Table 1-1.

If the active DL BWP and the initial DL BWP for a UE have same SCS and same CP length and the active DL BWP includes all RBs of the CORESET with index 0, or the active DL BWP is the initial DL BWP, or the active DL BWP includes all RBs of an MBS frequency resource provided by cfr-ConfigMCCH-MTCH or cfr-ConfigMCCH-MTCH-RedCap as described in clause 18, the CORESET configured for Type0-PDCCH CSS set has CORESET index 0 and the Type0-PDCCH CSS set has search space set index 0.

If the active DL BWP and an MBS frequency resource provided by cfr-ConfigMCCH-MTCH or cfr-ConfigMCCH-MTCH-RedCap or determined by CORESET with index 0 when cfr-ConfigMCCH-MTCH or cfr-ConfigMCCH-MTCH-RedCap is not provided for a UE have same SCS and same CP length and the active DL BWP includes all RBs of the MBS frequency resource, and if the UE is provided searchSpaceMCCH or searchSpaceMTCH for Type0B-PDCCH CSS set on the primary cell or for Type3-PDCCH CSS set on a secondary cell, the UE monitors PDCCH for detection of broadcast DCI formats, as described in clause 18, on the active DL BWP.

For a DL BWP, if a UE is not provided searchSpaceOtherSystemInformation for Type0A-PDCCH CSS set, the UE does not monitor PDCCH for Type0A-PDCCH CSS set on the DL BWP. The CCE aggregation levels and the number of PDCCH candidates per CCE aggregation level for Type0A-PDCCH CSS set are given in Table 1-1.

For a DL BWP, if a UE is not provided ra-SearchSpace for Type1-PDCCH CSS set, the UE does not monitor PDCCH for Type1-PDCCH CSS set on the DL BWP. If the UE has not been provided a Type3-PDCCH CSS set, or a Type1A-PDCCH CSS set, or a USS set and the UE has received a C-RNTI and has been provided a Type1-PDCCH CSS set, the UE monitors PDCCH candidates for DCI format 0_0 and DCI format 1_0 with CRC scrambled by the C-RNTI in the Type1-PDCCH CSS set.

If a UE is not provided pagingSearchSpace for Type2-PDCCH CSS set, the UE does not monitor PDCCH for Type2-PDCCH CSS set on the DL BWP. The CCE aggregation levels and the number of PDCCH candidates per CCE aggregation level for Type2-PDCCH CSS set are given in Table 1-1.

If a UE is not provided pei-SearchSpace for Type2A-PDCCH CSS set, the UE does not monitor PDCCH for Type2A-PDCCH CSS set on the DL BWP. The CCE aggregation levels and the maximum number of PDCCH candidates per CCE aggregation level for Type2A-PDCCH CSS set are given in Table 1-1. If the UE is provided pei-SearchSpace with zero value for the Type2A-PDCCH CSS set index, and for the SS/PBCH block and CORESET multiplexing patterns 2 and 3, the UE determines PDCCH monitoring occasions as described in clause 13 and the CCE aggregation levels and the number of PDCCH candidates per CCE aggregation level for Type2A-PDCCH CSS set are given in Table 1-1.

If a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13, and the UE is provided a C-RNTI, the UE monitors PDCCH candidates only at monitoring occasions associated with a SS/PBCH block, where the SS/PBCH block is determined by the most recent of
a MAC CE activation command indicating a TCI state of the active BWP that includes a CORESET with index 0, as described in [6, TS 38.214], where the TCI-state includes a CSI-RS which is quasi-co-located with the SS/PBCH block, or
a random access procedure that is not initiated by a PDCCH order that triggers a contention-free random access procedure, or
configured-grant based PUSCH transmission in RRC_INACTIVE state as described in clause 19.1.

If a UE monitors PDCCH candidates for DCI formats with CRC scrambled by a C-RNTI and the UE is provided a non-zero value for searchSpaceID in PDCCH-ConfigCommon for a Type0/0A/1A/2-PDCCH CSS set, or monitors PDCCH candidates for DCI formats with CRC scrambled by a MCCH-RNTI or a G-RNTI for broadcast and the UE is provided a non-zero value for searchSpaceMCCH and searchSpaceMTCH in PDCCH-ConfigCommon for a Type0B-PDCCH CSS set, or monitors PDCCH candidates for DCI formats with CRC scrambled by a multicast-MCCH-RNTI or a G-RNTI for multicast in RRC_INACTIVE state and the UE is provided a non-zero value for searchSpaceMulticastMCCH and searchSpaceMulticastMTCH in PDCCH-ConfigCommon for a Type0B-PDCCH CSS set, the UE determines monitoring occasions for PDCCH candidates of the Type0/0A/1A/2-PDCCH CSS set, or of the Type0B-PDCCH CSS set, respectively, based on the search space set associated with the value of searchSpaceID.

The UE may assume that the DM-RS antenna port associated with PDCCH receptions in the CORESET configured by pdcch-ConfigSIB1 in MIB, the DM-RS antenna port associated with corresponding PDSCH receptions, and the corresponding SS/PBCH block are quasi co-located with respect to average gain, quasi co-location ‘typeA’ and ‘typeD’ properties, when applicable [6, TS 38.214], if the UE is not provided a TCI state indicating quasi co-location information of the DM-RS antenna port for PDCCH reception in the CORESET. The value for the DM-RS scrambling sequence initialization is the cell ID. For operation without shared spectrum channel access in FR1 and FR2-1, a SCS is provided by subCarrierSpacingCommon in MIB. For operation with shared spectrum channel access in FR1 and for operation in FR2-2, a SCS is same as the SCS of a corresponding SS/PBCH block.

For single cell operation or for operation with carrier aggregation in a same frequency band, a UE does not expect to monitor a PDCCH in a Type0/0A/B/2/3-PDCCH CSS set or in a USS set if a DM-RS for monitoring a PDCCH in a Type1-PDCCH CSS set is not configured with same qcl-Type set to ‘typeD’ properties [6, TS 38.214] with a DM-RS for monitoring the PDCCH in the Type0/0A/0B/2/3-PDCCH CSS set or in the USS set, and if the PDCCH or an associated PDSCH overlaps in at least one symbol with a PDCCH the UE monitors in a Type1-PDCCH CSS set or with an associated PDSCH.

If a UE is provided
one or more search space sets by corresponding one or more of searchSpaceZero, searchSpaceSIB1, search SpaceOtherSystemInformation, pagingSearchSpace, ra-SearchSpace, and
a C-RNTI, an MCS-C-RNTI, or a CS-RNTI
   the UE monitors PDCCH candidates for DCI format 0_0 and DCI format 1_0 with CRC scrambled by the C-RNTI, the MCS-C-RNTI, or the CS-RNTI in the one or more search space sets in a slot where the UE monitors PDCCH candidates for at least a DCI format 0_0 or a DCI format 1_0 with CRC scrambled by SI-RNTI, RA-RNTI, MsgB-RNTI, or P-RNTI.

If a UE is provided
one or more search space sets by corresponding one or more of searchSpaceZero, searchSpaceSIB1, searchSpaceOtherSystemInformation, pagingSearchSpace, pei-SearchSpace, ra-SearchSpace, or a CSS set by PDCCH-Config, and
a SI-RNTI, a P-RNTI, a PEI-RNTI, a RA-RNTI, a MsgB-RNTI, a SFI-RNTI, an INT-RNTI, a TPC-PUSCH-RNTI, a TPC-PUCCH-RNTI, or a TPC-SRS-RNTI,
   then, for a RNTI from any of these RNTIs, the UE does not expect to process information from more than one DCI format with CRC scrambled with the RNTI per slot.

TABLE 1-1
CCE aggregation levels and maximum number of
PDCCH candidates per CCE aggregation level
for CSS sets configured by searchSpaceSIB1

| CCE | Number of |
|---|---|
| Aggregation Level | Candidates |
| 4 | 4 |
| 8 | 2 |
| 16 | 1 |

For each DL BWP configured to a UE in a serving cell, the UE can be provided by higher layer signalling with
P≤3 CORESETs if coresetPoolIndex is not provided, or if a value of coresetPoolIndex is same for all CORESETs if coresetPoolIndex is provided,
P≤5 CORESETs if coresetPoolIndex is not provided for a first CORESET, or is provided and has a value 0 for a first CORESET, and is provided and has a value 1 for a second CORESET.

For each CORESET, the UE is provided the following by ControlResourceSet:
a CORESET index p, by controlResourceSetId or by controlResourceSetId-v1610, where
0<p<12 if coresetPoolIndex is not provided, or if a value of coresetPoolIndex is same for all CORESETs if coresetPoolIndex is provided;
0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect:
to be configured a set of resource blocks of a CORESET that includes more than four sub-sets of resource blocks that are not contiguous in frequency,
any RE of a CORESET to overlap with any RE determined from
Ite-CRS-ToMatchAround or LTE-CRS-PatternList, if the UE is not provided pdcchCandidateReception-WithCRSOverlap, or
a SS/PBCH block.

If a UE is provided two TCI states indicating quasi co-location information of the DM-RS antenna port for PDCCH reception in a CORESET associated with a Type3-PDCCH CSS set, the UE may assume the quasi-co-location information indicated in both of the two TCI states for the PDCCH reception in the CORESET.

For each CORESET in a DL BWP of a serving cell, a respective frequencyDomainResources provides a bitmap:
if a CORESET is not associated with any search space set configured with freqMonitor Locations, the bits of the bitmap have a one-to-one mapping with non-overlapping groups of 6 consecutive PRBs, in ascending order of the PRB index in the DL BWP bandwidth of

$${N}_{RB}^{BWP}$$

PRBs with starting common RB position

$${N}_{BWP}^{start} ,$$

where the first common RB of the first group of 6 PRBs has common RB index

$$6 \cdot ⌈ {N}_{BWP}^{start} / 6 ⌉$$

if rb-Offset is not provided, or the first common RB of the first group of 6 PRBs has common RB index

$${N}_{BWP}^{start} + {N}_{RB}^{offset}$$

where

$${N}_{RB}^{offset}$$

is provided by rb-Offset.
if a CORESET is associated with at least one search space set configured with freqMonitorLocations, the first

$${N}_{R B G , set 0}^{s i z e}$$

bits of the bitmap have a one-to-one mapping with non-overlapping groups of 6 consecutive PRBs, in ascending order of the PRB index in each RB set k in the DL BWP bandwidth of

$${N}_{R B}^{BWP}$$

PRBs with starting common RB position

$$R {B}_{s 0 + k , DL}^{start , μ}$$

[6, TS 38.214], where the first common RB of the first group of 6 PRBs has common RB index

$$R {B}_{s 0 + k , DL}^{start , μ} + {N}_{RB}^{offset}$$

and k is indicated by freqMonitorLocations if provided for a search space set; otherwise, k=0.

$${N}_{R B G , set 0}^{s i z e} = ⌊ ( {N}_{R B , set 0}^{s i z e} - {N}_{R B}^{offset} ) / 6 ⌋ , {N}_{R B , set 0}^{s i z e}$$

is a number of available PRBs in the RB set 0 for the DL BWP, and

$${N}_{R B}^{offset}$$

is provided by rb-Offset or

$${N}_{R B}^{offset} = 0$$

if rb-Offset is not provided. If a UE is provided RB sets in the DL BWP, the UE expects that the RBs of the CORESET are within the union of the PRBs in the RB sets of the DL BWP.

For each CORESET provided by cfr-ConfigMCCH-MTCH or cfr-ConfigMCCH-MTCH-RedCap or cfr-ConfigMulticast in a CFR of a serving cell, the quantities

$${N}_{R B}^{BWP} and {N}_{B W P}^{start}$$

in this clause are replaced by the size of CFR

$${N}_{RB}^{CFR}$$

and starting common RB position of CFR

$${N}_{CFR}^{start} ,$$

respectively.

For a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList and has not received a MAC CE activation command for one of the TCI states as described in [11, TS 38.321], the UE assumes that the DM-RS antenna port associated with PDCCH receptions is quasi co-located with the SS/PBCH block the UE identified during the initial access procedure, or for a most recent configured grant PUSCH transmission as described in clause 19 for a same HARQ process;
if a UE has been provided a configuration of more than one TCI states by tci-StatesPDCCH-ToAddList and tci-StatesPDCCH-ToReleaseList for the CORESET as part of Reconfiguration with sync procedure as described in [12, TS 38.331] and has not received a MAC CE activation command for one of the TCI states as described in [11, TS 38.321], the UE assumes that the DM-RS antenna port associated with PDCCH receptions is quasi co-located with the SS/PBCH block or the CSI-RS resource the UE identified during the random access procedure initiated by the Reconfiguration with sync procedure as described in [12, TS 38.331].

For a CORESET with index 0,
if the UE is provided TCI-State and follow UnifiedTCI-State for the CORESET, the UE assumes that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the indicated TCI-State [6, TS 38.214],
else if the UE is provided dl-OrJointTCI-StateList and is indicated a first TCI-State and a second TCI-State, and apply-IndicatedTCIState for the CORESET,
if the CORESET is associated with a Type 0/0A/2-PDCCH CSS set that has search space set index 0,
   if apply-IndicatedTCIState=‘first’, the UE assumes that a DM-RS antenna port for PDCCH receptions in the CORESET is quasi co-located with the reference signals provided by the first TCI-State,
   if apply-IndicatedTCIState=‘second’, the UE assumes that a DM-RS antenna port for PDCCH receptions in the CORESET is quasi co-located with the reference signals provided by the second TCI-State,
   if apply-IndicatedTCIState=‘none’, the UE assumes that a DM-RS antenna port for PDCCH receptions in the CORESET is quasi co-located with the one or more DL RS configured by a TCI state, where the TCI state is indicated by a MAC CE activation command for the CORESET, if any
else
   if apply-IndicatedTCIState=‘first’, the UE assumes that a DM-RS antenna port for PDCCH receptions in the CORESET is quasi co-located with the reference signals provided by the first TCI-State,
   if apply-IndicatedTCIState=‘second’, the UE assumes that a DM-RS antenna port for PDCCH receptions in the CORESET is quasi co-located with the reference signals provided by the second TCI-State,
   if apply-IndicatedTCIState=‘both’, the UE assumes that a DM-RS antenna port for PDCCH receptions in the CORESET is quasi co-located with the reference signals provided by the first and the second TCI-State,
   if apply-IndicatedTCIState=‘none’, the UE assumes that a DM-RS antenna port for PDCCH receptions in the CORESET is quasi co-located with the one or more DL RS configured by a TCI state, where the TCI state is indicated by a MAC CE activation command for the CORESET.
else, the UE assumes that a DM-RS antenna port for PDCCH receptions in the CORESET is quasi co-located with
   the one or more DL RS configured by a TCI state, where the TCI state is indicated by a MAC CE activation command for the CORESET, if any, or
   a SS/PBCH block the UE identified during a most recent random access procedure not initiated by a PDCCH order that triggers a contention-free random access procedure, if no MAC CE activation command indicating a TCI state for the CORESET is received after the most recent random access procedure, or a SS/PBCH block the UE identified during a most recent configured grant PUSCH transmission as described in clause 19.

For a CORESET other than a CORESET with index 0, if a UE is provided a single TCI state for a CORESET, or if the UE receives a MAC CE activation command for one or two of the provided TCI states for a CORESET, the UE assumes that the DM-RS antenna port associated with PDCCH receptions in the CORESET is quasi co-located with the one or more DL RS configured by the TCI states. For a CORESET with index 0, the UE expects that a CSI-RS configured with qcl-Type set to ‘typeD’ in a TCI state indicated by a MAC CE activation command for the CORESET is provided by a SS/PBCH block,
if the UE receives a MAC CE activation command for one of the TCI states, the UE applies the activation command in the first slot that is after slot

$$k + 3 {N}_{slot}^{subframe , μ} + {2}^{μ} \cdot {k}_{m a c}$$

where k is the slot where the UE would transmit a PUCCH with HARQ-ACK information for the PDSCH providing the activation command, μ is the SCS configuration for the PUCCH in the slot when the activation command is applied, and k_{mac} is a number of slots for SCS configuration μ=0 provided by kmac or k_{mac}=0 if kmac is not provided.

If a UE is provided TCI-State in dl-OrJointTCI-StateList, a DM-RS antenna port for PDCCH receptions in a CORESET, other than a CORESET with index 0, associated only with USS sets and/or Type3-PDCCH CSS sets, and a DM-RS antenna port for PDSCH receptions scheduled by DCI formats provided by PDCCH receptions in the CORESET are quasi co-located with reference signals provided by the indicated TCI-State [6, TS 38.214].

If a UE is provided follow UnifiedTCI-State for a CORESET, other than a CORESET with index 0, associated at least with CSS sets other than Type3-PDCCH CSS sets, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated TCI-State.

If a UE is provided dl-Or JointTCI-StateList and is indicated a first TCI-State and a second TCI-State, and is provided apply-IndicatedTCIState for a CORESET, other than a CORESET with index 0,
if the CORESET is associated only with USS sets and/or Type3-PDCCH CSS sets,
   if apply-IndicatedTCIState=‘first’, the UE assumes that a DM-RS antenna port for PDCCH receptions in the CORESET is quasi co-located with the reference signals provided by the first TCI-State,
   if apply-IndicatedTCIState=‘second’, the UE assumes that a DM-RS antenna port for PDCCH receptions in the CORESET is quasi co-located with the reference signals provided by the second TCI-State,
   if apply-IndicatedTCIState=‘both’, the UE assumes that a DM-RS antenna port for PDCCH receptions in the CORESET is quasi co-located with the reference signals provided by the first TCI-State and the second TCI-State,
if the CORESET is associated at least with CSS sets other than Type3-PDCCH CSS sets,
   if apply-IndicatedTCIState=‘first’, the UE assumes that a DM-RS antenna port for PDCCH receptions in the CORESET is quasi co-located with the reference signals provided by the first TCI-State,
   if apply-IndicatedTCIState=‘second’, the UE assumes that a DM-RS antenna port for PDCCH receptions in the CORESET is quasi co-located with the reference signals provided by the second TCI-State,
   if apply-IndicatedTCIState=‘both’, the UE assumes that a DM-RS antenna port for PDCCH receptions in the CORESET is quasi co-located with the reference signals provided by the first TCI-State and the second TCI-State,
   if apply-IndicatedTCIState=‘none’, the UE assumes that a DM-RS antenna port for PDCCH receptions in the CORESET is quasi co-located with the one or more DL RS configured by a TCI state indicated by a MAC CE activation command for the CORESET.

If the UE is provided dl-Or JointTCI-StateList and
is not provided coresetPoolIndex or is provided coresetPoolIndex with a value of 0 for first CORESETs on an active DL BWP of a serving cell,
is provided coresetPoolIndex with a value of 1 for second CORESETs on the active DL BWP of the serving cells, and
is provided follow UnifiedTCI-State for the first and second CORESETs, that do not include a CORESET with index 0 and are associated only with USS sets and/or Type3-PDCCH CSS sets, or with CSS sets other than Type3-PDCCH CSS sets,

### the UE

assumes that DM-RS antenna ports for PDCCH receptions in the first and second CORESETs, and DM-RS antenna ports for PDSCH receptions scheduled by DCI formats provided by PDCCH receptions in the first and second CORESETs, are quasi co-located with the reference signals provided by indicated TCI-State specific to the first and second CORESETs, respectively,
transmits PUSCH scheduled by DCI formats provided by PDCCH receptions in the first and second CORESETs using a spatial domain filter corresponding to TCI-State or TCI-UL-State specific to the first and second CORESETs, respectively.

If a UE is provided two coresetPoolIndex values 0 and 1 for first and second CORESETs, or is not provided coresetPoolIndex value for first CORESETs and is provided coresetPoolIndex value of 1 for second CORESETs, respectively, a MAC CE command activating TCI states for the first or second CORESETs [11, TS 38.321] can include coresetPoolIndex value 0 or 1
if the UE is provided SSB_MTC_AdditionalPCI, the activated TCI states for the first and/or the second CORESETs are for physCellId from ServingCellConfigCommon and the activated TCI states for either the first or the second CORESETs can be for physCellId from additionalPCI.

If a UE is provided by simultaneousTCI-UpdateList1 or simultaneousTCI-UpdateList2 up to two lists of cells for simultaneous TCI state activation, the UE applies the antenna port quasi co-location provided by one or two TCI-State each with same activated tci-StateID value, to CORESETs with a same index in all configured DL BWPs of all configured cells in a list determined from a serving cell index, where one or two tci-StateID, the CORESET index, and the serving cell index are provided by a MAC CE command.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId,
an association between the search space set s and a CORESET p by controlResourceSetId or by controlResourceSetId-v1610,
a PDCCH monitoring periodicity of ks slots and a PDCCH monitoring offset of oₛ slots, by monitoringSlotPeriodicityAndOffset or by monitoringSlotPeriodicityAndOffset-r17,
a PDCCH monitoring pattern within a slot, indicating first symbol(s) of the CORESET for PDCCH monitoring within each slot where the UE monitors PDCCH, by monitoringSymbolsWithinSlot,
a duration of Tₛ<kₛ indicating a number of slots that the search space set s exists by duration, or a number of slots in consecutive groups of slots where the search space set s can exist by duration-r17,
a bitmap, by monitoringSlotsWithinSlotGroup, that applies per group of slots and provides a PDCCH monitoring pattern indicating slots in a group of slots for PDCCH monitoring,
   a size of the group of slots is same as a size of monitoringSlotsWithinSlotGroup
   for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ,
   for a Type1-PDCCH CSS set provided by ra-SearchSpace in SIB1, the PDCCH monitoring pattern indicates only up to 1 slot in the group of slots for PDCCH monitoring,
   for a Type0-PDCCH CSS set or for a TypeOA-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup,
a number of PDCCH candidates

$${M}_{s}^{( L )}$$

per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively,
an indication that search space set s is either a CSS set or a USS set by searchSpace Type
if search space set s is a CSS set,
an indication by dci-Format0-0-AndFormat1-0 to monitor PDCCH candidates for DCI format 0_0 and DCI format 1_0,
   an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level,
   an indication by dci-Format2-1 to monitor PDCCH candidates for DCI format 2_1,
   an indication by dci-Format2-2 to monitor PDCCH candidates for DCI format 2_2,
   an indication by dci-Format2-3 to monitor PDCCH candidates for DCI format 2_3,
   an indication by dci-Format2-4 to monitor PDCCH candidates for DCI format 2 4,
   an indication by dci-Format2-6 to monitor PDCCH candidates for DCI format 2 6,
   an indication by dci-Format2-9 to monitor PDCCH candidates for DCI format 2_9,
   an indication by dci-Format4-0 to monitor PDCCH candidates for DCI format 4 0,
   an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively,
an indication by searchSpaceLinkingId that search space set s is linked to another search space set for which is provided a same value for searchSpaceLinkingId,
if search space set s is a USS set,
   an indication by dci-Formats to monitor PDCCH candidates either for DCI format 0_0 and DCI format 1_0, or for DCI format 0_1 and DCI format 1_1, or
   an indication by dci-FormatsExt to monitor PDCCH candidates for DCI format 0_2 and DCI format 1_2, or for DCI format 0_1, DCI format 1_1, DCI format 0_2, and DCI format 1_2, or
   an indication by dci-FormatsMC to monitor PDCCH candidates for one or both of DCI format 0_3 and DCI format 1_3, or
   an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8,
a bitmap by freqMonitorLocations, if provided, to indicate an index of one or more RB sets for the search space set s, where the MSB k in the bitmap corresponds to RB set k−1 in the DL BWP. For RB set k indicated in the bitmap, the first PRB of the frequency domain monitoring location confined within the RB set is given by

$$R {B}_{s 0 + k , DL}^{start , μ} + {N}_{RB}^{offset} ,$$

where

$$R {B}_{s 0 + k , DL}^{start , μ}$$

is the index of first common RB of the RB set k [6, TS 38.214], and

$${N}_{RB}^{offset}$$

is provided by rb-Offset or

$${N}_{R B}^{offset} = 0$$

if rb-Offset is not provided. For each RB set with a corresponding value of 1 in the bitmap, the frequency domain resource allocation pattern for the monitoring location is determined based on the first

$${N}_{R B G , set 0}^{s i z e}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ}$$

[4, TS 38.211] in a frame with number n_{f} if

$$( {n}_{f} {N}_{slot}^{frame , μ} + {n}_{s , f}^{μ} - {o}_{s} ) mod {k}_{s} = 0.$$

The UE monitors PDCCH candidates for search space set s for Tₛ consecutive slots, starting from slot

$${n}_{s , f}^{μ}$$

and does not monitor PDCCH candidates for search space set s for the next kₛ−Tₛ consecutive slots. If monitoringSlotsWithinSlotGroup is provided, for search space set s, the UE determines that the slot with number

$${n}_{s , f}^{μ}$$

[4, TS 38.211] in a frame with number n_{f} satisfying

$$( {n}_{f} {N}_{slot}^{frame , μ} + {n}_{s , f}^{μ} - {o}_{s} ) mod {k}_{s} = 0.$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ} ,$$

and does not monitor PDCCH candidates for search space set s for the next kₛ−Tₛ consecutive slots.

A USS at CCE aggregation level L∈{1, 2, 4,8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value ncr of nCI-Value associated with a set of serving cells MC-DCI-SetofCells, are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS,

$${Y}_{p , {n}_{s , f}^{μ}} = 0 ;$$

for a USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per RB set
   for CORESET 0, the CCEs are obtained prior to puncturing, if any, of corresponding RBs [4, TS 38.211];
n_{CI} is
   the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
   the nCI-Value provided for the set of serving cells MC-DCI-SetofCells, if MC-DCI-SetofCells is provided;
   otherwise, including for any CSS, n_{CI}=0

$${m}_{s , {n}_{CI}}^{( L )} = 0 , … , {M}_{s , {n}_{CI}}^{( L )} - 1 ,$$

where

$${M}_{s , {n}_{CI}}^{( L )}$$

is the number of PDCCH candidates the UE is configured to monitor for aggregation level L of a search space set s for a serving cell corresponding to n_{CI};
for any CSS,

$${M}_{s , max}^{( L )} = {M}_{s , 0}^{( L )} ;$$

for a USS,

$${M}_{s , max}^{( L )}$$

is the maximum of

$${M}_{s , {n}_{CI}}^{( L )}$$

over all configured n_{CI} values for a CCE aggregation level L of search space set s;
the RNTI value used for n_{RNTI} is the C-RNTI.

For search space sets sᵢ and sⱼ that include searchSpaceLinkingId with same value, a UE monitors, in monitoring occasions with same index according to each of search space sets sᵢ and sⱼ in a slot, PDCCH candidate

$${m}_{{s}_{i} , {n}_{CI}}^{( L )} and {m}_{{s}_{j} , {n}_{CI}}^{( L )} ,$$

with

$${m}_{{s}_{i} , {n}_{CI}}^{( L )} = {m}_{{s}_{j} , {n}_{CI}}^{( L )} ,$$

for detection of a DCI format with same information. The UE expects kₛ_{ᵢ}=kₛ_{ⱼ}, oₛ_{ᵢ}=oₛ_{ⱼ}, Tₛ_{ᵢ}=Tₛ_{ⱼ},

$${M}_{{s}_{i}}^{( L )} = {M}_{{s}_{j}}^{( L )} ,$$

and a same number of non-overlapping PDCCH monitoring occasions per slot based on corresponding monitoringSymbolsWithinSlot, for search space sets sᵢ and sⱼ. For CORESET pᵢ associated with the search space set sᵢ and for CORESET pⱼ associated with the search space set sⱼ, the UE is provided tci-PresentInDCI or tci-PresentDCI-1-2 for either none or both of CORESETs pᵢ and pⱼ. For CORESET pᵢ associated with the search space set si and for CORESET pⱼ associated with the search space set sⱼ, the UE is either not provided coresetPoolIndex value of 1 for any of the two CORESETs, or is provided coresetPoolIndex value of 1 for both CORESETs.

A UE can indicate by numBD-twoPDCCH-r17 a capability for counting PDCCH candidates

$${m}_{{s}_{i} , {n}_{CI}}^{( L )} and {m}_{{s}_{j} , {n}_{CI}}^{( L )}$$

either as 2 PDCCH candidates or as 3 PDCCH candidates.

For search space sets sᵢ and sⱼ that include searchSpaceLinkingId with same value, and for search space sets sₖ and sₗ that include searchSpaceLinkingId with same value, a UE expects to simultaneously monitor PDCCH candidates

$${m}_{{s}_{i} , {n}_{CI , 1}}^{( 8 )} = {m}_{{s}_{j} , {n}_{CI , 1}}^{( 8 )} , and {m}_{{s}_{k} , {n}_{CI , 2}}^{( 16 )} = {m}_{{s}_{l} , {n}_{CI , 2}}^{( 16 )}$$

only if a first CCE of

$${m}_{{s}_{i} , {n}_{CI , 1}}^{( 8 )} or {m}_{{s}_{j} , {n}_{CI , 1}}^{( 8 )}$$

has different index than a first CCE of

$${m}_{{s}_{k} , {n}_{CI , 2}}^{( 16 )} or {m}_{{s}_{l} , {n}_{CI , 2}}^{( 16 )}$$

in a CORESET configured with cce-REG-MappingType=‘nonInterleaved’ and with duration of one symbol.

If a UE
is provided monitoringCapabilityConfig=r16monitoringcapability for a downlink cell,
is provided, by searchSpaceLinkingId a same value for search space sets sᵢ and sⱼ on the downlink cell, and
indicates numBD-twoPDCCH-r17 with value of 3,
   the UE counts each PDCCH candidate for the one of the search space sets sᵢ and sⱼ that the UE monitors PDCCH in the later span, as two PDCCH candidates. The UE does not expect a first PDCCH candidate from search space set sᵢ or sⱼ and a second PDCCH candidate from a search space set sₖ that does not include searchSpaceLinkingId to use a same set of CCEs and same scrambling in a same CORESET, and provide respective first and second DCI formats with same size, in any span other than the first span in a slot.

A UE does not expect to be provided freqMonitorLocations for a search space set s in a serving cell if intraCellGuardBandsDL-List indicates that no intra-cell guard-bands are configured for the serving cell.

A UE that
is configured for operation with carrier aggregation, and
indicates support of search space sharing through searchSpaceSharingCA-UL or through searchSpaceSharingCA-DL, and
has a PDCCH candidate with CCE aggregation level L in CORESET p associated with search space set sᵢ of a scheduling cell for detection of a first DCI format, other than DCI format 0_0 or DCI format 1_0, having a first size and scheduling
   PUSCH transmission or configured grant Type 2 PUSCH release on serving cell n_{CI,2}, or
   PDSCH reception or having associated HARQ-ACK information without scheduling PDSCH reception on serving cell n_{CI,2}, can receive a corresponding PDCCH through a PDCCH candidate with CCE aggregation level L in CORESET p associated with search space set sⱼ of the scheduling cell for detection of a second DCI format having a second size and associated with scheduling on serving cell n_{CI,1} if the first size and the second size are same and if neither of search space sets sᵢ and sⱼ includes searchSpaceLinkingId.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP. If the UE monitors PDCCH candidates for detection of one or both of DCI format 0_3 and DCI format 1_3 for scheduling on serving cells from a set of serving cells, the serving cell for counting the size of one or both DCI format 0_3 and DCI format 1_3, respectively, is
the scheduling cell, if the scheduling cell is included in the set of serving cells and the UE is provided search space sets for the PDCCH candidates only on the scheduling cell,
a serving cell from the set of serving cells, if search space sets with same searchSpaceId for one or both of DCI format 0_3 and DCI format 1_3, respectively, are provided on the serving cell and on the scheduling cell.

A UE does not expect to detect, in a same PDCCH monitoring occasion, a DCI format with CRC scrambled by a SI-RNTI, RA-RNTI, MsgB-RNTI, TC-RNTI, P-RNTI, C-RNTI, CS-RNTI, MCS-RNTI, MCCH-RNTI, G-RNTI, G-CS-RNTI, or multicast-MCCH-RNTI and a DCI format with CRC scrambled by a SL-RNTI or a SL-CS-RNTI for scheduling respective PDSCH reception and PSSCH transmission on a same serving cell.

A PDCCH candidate with index

$${m}_{{s}_{j} , {n}_{CI}}^{( L )}$$

for a search space set sⱼ using a set of L CCEs in a CORESET p on the active DL BWP for serving cell n_{CI}, or for set of serving cells associated with nCI-Value having value n_{CI}, is not counted for monitoring if there is a PDCCH candidate with index

$${m}_{{s}_{i} , {n}_{CI}}^{( L )}$$

for a search space set sᵢ<sⱼ, or if there is a PDCCH candidate with index

$${n}_{{s}_{j} , {n}_{CI}}^{( L )} and {m}_{{s}_{j} , {n}_{CI}}^{( L )} < {m}_{{s}_{j} , {n}_{CI}}^{( L )} ,$$

in the CORESET p on the active DL BWP for serving cell n_{CI}, or for set of serving cells n_{CI}, respectively, using a same set of L CCEs, the PDCCH candidates have identical scrambling, and the corresponding DCI formats for the PDCCH candidates have a same size; otherwise, the PDCCH candidate with index

$${m}_{{s}_{j} , {n}_{CI}}^{( L )}$$

is counted for monitoring.

For search space sets sᵢ and sⱼ that include searchSpaceLinkingId with same value, and for search space set sₖ that does not include searchSpaceLinkingId, when a UE
monitors PDCCH candidates

$${m}_{{s}_{i} , {n}_{CI , 1}}^{( L )} = {m}_{{s}_{j} , {n}_{CI , 1}}^{( L )}$$

for detection of a first DCI format,
monitors PDCCH candidate

$${m}_{{s}_{k} , {n}_{CI , 2}}^{( L )}$$

for detection of a second DCI format having a same size as the first DCI format,
the PDCCH candidate

$${m}_{{s}_{i} , {n}_{CI , 1}}^{( L )} ,$$

or the PDCCH candidate

$${m}_{{s}_{j} , {n}_{CI , 1}}^{( L )} ,$$

and the PDCCH candidate

$${m}_{{s}_{k} , {n}_{CI , 2}}^{( L )}$$

have identical scrambling and use a same set of CCEs over same symbols in a slot in a CORESET p,
   the PDCCH candidate

$${m}_{{s}_{k} , {n}_{CI , 2}}^{( L )}$$

is not counted for monitoring and the UE assumes that a detected DCI format is the first DCI format. A UE may monitor PDCCH candidate

$${m}_{{s}_{k} , {n}_{CI , 2}}^{( L )}$$

depending on a corresponding capability [18, TS 38.306].

For search space sets sᵢ and sⱼ that include searchSpaceLinkingId with same value, and for search space set sₖ that does not include searchSpaceLinkingId, when a UE
monitors PDCCH candidates

$${m}_{{s}_{i} , {n}_{CI , 1}}^{( 8 )} = {m}_{{s}_{j} , {n}_{CI , 1}}^{( 8 )}$$

for detection of a first DCI format and monitors PDCCH candidate

$${m}_{{s}_{k} , {n}_{CI , 2}}^{( 16 )}$$

for detection of a second DCI format, or monitors PDCCH candidates

$${m}_{{s}_{i} , {n}_{CI , 1}}^{( 16 )} = {m}_{{s}_{j} , {n}_{CI , 1}}^{( 16 )}$$

for detection of the first DCI format and monitors PDCCH candidate

$${m}_{{s}_{k} , {n}_{CI , 2}}^{( 8 )}$$

for detection of the second DCI format, and
one of the PDCCH candidates

$${m}_{{s}_{i} , {n}_{CI , 1}}^{( 8 )} and {m}_{{s}_{j} , {n}_{CI , 1}}^{( 8 )} ,$$

and the PDCCH candidate

$${m}_{{s}_{k} , {n}_{CI , 2}}^{( 16 )} ,$$

or one of the PDCCH candidates

$${m}_{{s}_{i} , {n}_{CI , 1}}^{( 16 )} and {m}_{{s}_{j} , {n}_{CI , 1}}^{( 16 )} ,$$

and the PDCCH candidate

$${m}_{{s}_{k} , {n}_{CI , 2}}^{( 8 )} ,$$

have a first CCE with same index and are simultaneously monitored in a CORESET p with cce-REG-MappingType=‘nonInterleaved’ and duration of one symbol,
   the UE assumes that a detected DCI format is the first DCI format.

For search space sets sᵢ and sⱼ, that include searchSpaceLinkingId with same value, and for search space sets sₖ and sₗ that include searchSpaceLinkingId with same value, and for detection of DCI formats with same size, a UE expects different CCEs or different scrambling in a CORESET p for any of first PDCCH candidates

$${m}_{{s}_{i} , {n}_{CI , 1}}^{( L )} and {m}_{{s}_{j} , {n}_{CI , 1}}^{( L )} ,$$

with

$${m}_{{s}_{i} , {n}_{CI , 1}}^{( L )} = {m}_{{s}_{j} , {n}_{CI , 1}}^{( L )}$$

and any of second PDCCH candidates

$${m}_{{s}_{k} , {n}_{CI , 2}}^{( L )} and {m}_{{s}_{l} , {n}_{CI , 2}}^{( L )} ,$$

with

$${m}_{{s}_{k} , {n}_{CI , 2}}^{( L )} = {m}_{{s}_{l} , {n}_{CI , 2}}^{( L )}$$

that the UE would simultaneously monitor.

Table 1-2 provides the maximum number of monitored PDCCH candidates,

$${M}_{PDCCH}^{max , slot , μ} ,$$

per slot for a UE in a DL BWP with SCS configuration μ for operation with a single serving cell.

TABLE 1-2
Maximum number M_{PDCCH}^{max, slot, μ} of monitored
PDCCH candidates per slot for a DL BWP with SCS configuration
μ ∈ {0, 1, 2, 3} for a single serving cell

| | Maximum number of monitored |
|---|---|
| | PDCCH candidates per slot and per |
| μ | serving cell M_{PDCCH}^{max, slot, μ} |
| 0 | 44 |
| 1 | 36 |
| 2 | 22 |
| 3 | 20 |

Table 1-2A provides the maximum number of monitored PDCCH candidates,

$${M}_{PDCCH}^{max , ( X , Y ) , μ} ,$$

per span for a UE in a DL BWP with SCS configuration μ for operation with a single serving cell.

TABLE 1-2A
Maximum number M_{PDCCH}^{max, (X, Y), μ} of monitored PDCCH
candidates in a span for combination (X, Y) for a DL BWP
with SCS configuration μ ∈ {0, 1} for a single serving cell

| | Maximum number M_{PDCCH}^{max, (X, Y), μ} of | | |
|---|---|---|---|
| | monitored PDCCH candidates per span | | |
| | for combination (X, Y) and per serving cell | | |
| μ | (2, 2) | (4, 3) | (7, 3) |
| 0 | 14 | 28 | 44 |
| 1 | 12 | 24 | 36 |

Table 1-2B provides the maximum number of monitored PDCCH candidates,

$${M}_{PDCCH}^{max , {X}_{s} , μ} ,$$

per group of Xₛ slots for combination (Xₛ, Yₛ) for a UE in a DL BWP with SCS configuration μ for operation with a single serving cell.

TABLE 1-2B
Maximum number M_{PDCCH}^{max, X}^{ₛ}^{, μ} of monitored PDCCH candidates
per group of Xₛ slots for combination (Xₛ, Yₛ) for a DL BWP
with SCS configuration μ ∈ {5, 6} for a single serving cell

Maximum number M_{PDCCH}^{max, X}^{ₛ}^{, μ} of monitored
PDCCH candidates in a group of Xₛ slots per
combination (Xₛ, Yₛ) and per serving cell

| μ | (4, 1) | (4, 2) | (8, 1) | (8, 4) |
|---|---|---|---|---|
| 5 | 20 | 20 | — | — |
| 6 | 10 | 10 | 20 | 20 |

Table 1-3 provides the maximum number of non-overlapped CCEs,

$${C}_{PDCCH}^{max , slot , μ} ,$$

for a DL BWP with SCS configuration μ that a UE is expected to monitor corresponding PDCCH candidates per slot for operation with a single serving cell.

CCEs for PDCCH candidates are non-overlapped if they correspond to:
different CORESET indexes, or
different first symbols for the reception of the respective PDCCH candidates.

TABLE 1-3
Maximum number C_{PDCCH}^{max, slot, μ} of non-overlapped
CCEs per slot for a DL BWP with SCS configuration
μ ∈ {0, 1, 2, 3} for a single serving cell

| | Maximum number of non- |
|---|---|
| | overlapped CCEs per slot and |
| μ | per serving cell C_{PDCCH}^{max, slot, μ} |
| 0 | 56 |
| 1 | 56 |
| 2 | 48 |
| 3 | 32 |

Table 1-3A provides the maximum number of non-overlapped CCEs,

$${C}_{PDCCH}^{max , ( X , Y ) , μ} ,$$

for a DL BWP with SCS configuration μ that a UE is expected to monitor corresponding PDCCH candidates per span for operation with a single serving cell.

TABLE 1-3A
Maximum number C_{PDCCH}^{max, (X, Y), μ} of non-overlapped
CCEs in a span for combination (X, Y) for a DL BWP with
SCS configuration μ ∈ {0, 1} for a single serving cell

| | Maximum number C_{PDCCH}^{max, (X, Y), μ} of | | |
|---|---|---|---|
| | non-overlapped CCEs per span for | | |
| | combination (X, Y) and per serving cell | | |
| μ | (2, 2) | (4, 3) | (7, 3) |
| 0 | 18 | 36 | 56 |
| 1 | 18 | 36 | 56 |

Table 1-3B provides the maximum number of non-overlapped CCES,

$${C}_{PDCCH}^{max , {X}_{s} , μ} ,$$

for a DL BWP with SCS configuration μ that a UE is expected to monitor corresponding PDCCH candidates per group of Xₛ slots for combination (Xₛ, Yₛ) for operation with a single serving cell.

TABLE 1-3B
Maximum number C_{PDCCH}^{max, X}^{ₛ}^{, μ} of non-overlapped CCEs
in a group of Xₛ slots for any combination (Xₛ, Yₛ) for a
DL BWP with SCS configuration μ ∈ {5, 6} for a single serving cell

| | Maximum number of non-overlapped CCEs in a group of Xₛ slots | | | |
|---|---|---|---|---|
| | per combination (Xₛ, Yₛ) and per serving cell C_{PDCCH}^{max, X}^{ₛ}^{, μ} | | | |
| μ | (4, 1) | (4, 2) | (8, 1) | (8, 4) |
| 5 | 32 | 32 | — | — |
| 6 | 16 | 16 | 32 | 32 |

In the following, if a UE monitors PDCCH candidates on a scheduling cell for detection of DCI format 0_3 or DCI format 1_3 for scheduling on serving cells from a set of serving cells, the serving cell for counting the PDCCH candidates and a corresponding number of non-overlapping CCEs is:
the scheduling cell, if the scheduling cell is included in the set of serving cells and the UE is provided search space sets for the PDCCH candidates only on the scheduling cell,
a serving cell from the set of serving cells, if search space sets with same searchSpaceId for one or both of DCI format 0_3 and DCI format 1_3, respectively, are provided on the serving cell and on the scheduling cell.

For the following procedures in this clause, downlink cells are scheduled cells on which a UE is provided search space sets.

If a UE:
does not report pdcch-BlindDetectionCA, pdcch-BlindDetectionCA1, pdcch-BlindDetectionCA2, or pdcch-BlindDetectionCA3, or is not provided BDFactorR, γ=R
reports pdcch-BlindDetectionCA, pdcch-BlindDetectionCA1, pdcch-BlindDetectionCA2, or pdcch-BlindDetectionCA3, the UE can be indicated by BDFactorR either γ=1 or γ=R.

If a UE is configured with

$${N}_{cells , 0}^{D L , μ} + {N}_{cells , 1}^{D L , μ}$$

downlink cells for which the UE is not provided monitoringCapabilityConfig, or is provided monitoringCapabilityConfig=r15monitoringcapability and is not provided CORESETPoolIndex, with associated PDCCH candidates monitored in the active DL BWPs of the scheduling cells using SCS configuration μ where

$${\sum }_{μ = 0}^{3} ( {N}_{cells , 0}^{DL , μ} + γ \cdot {N}_{cells , 1}^{DL , μ} ) \leq {N}_{cells}^{cap} ,$$

the UE is not required to monitor, on the active DL BWPs of the scheduling cells,
more than

$${M}_{PDCCH}^{total , slot , μ} = {M}_{PDCCH}^{max , slot , μ}$$

PDCCH candidates or more than

$${C}_{PDCCH}^{total , slot , μ} = {C}_{PDCCH}^{max , slot , μ}$$

non-overlapped CCEs per slot for each scheduled cell when the scheduling cell is from the

$${N}_{cells , 0}^{DL , μ}$$

downlink cells, or
more than

$${M}_{PDCCH}^{total , slot , μ} = γ \cdot {M}_{PDCCH}^{max , slot , μ}$$

PDCCH candidates or more than

$${C}_{PDCCH}^{total , slot , μ} = γ \cdot {C}_{PDCCH}^{max , slot , μ}$$

non-overlapped CCEs per slot for each scheduled cell when the scheduling cell is from the

$${N}_{cells , 1}^{DL , μ}$$

downlink cells,
more than

$${M}_{PDCCH}^{max , slot , μ}$$

PDCCH candidates or more than

$${C}_{PDCCH}^{max , slot , μ}$$

non-overlapped CCEs per slot for CORESETs with same coresetPoolIndex value for each scheduled cell when the scheduling cell is from the

$${N}_{cells , 1}^{D L , μ}$$

downlink cells.

$${N}_{cells}^{cap}$$

is replaced by

$${N}_{cells , r 15}^{c a p - r 16} ,$$

if a UE is configured with downlink cells for which the UE is provided both monitoringCapabilityConfig=r15monitoringcapability and monitoringCapabilityConfig=r16monitoringcapability.

$${N}_{cells}^{cap}$$

is replaced by

$${N}_{cells , r 15 / r 17}^{c a p - r 17} ,$$

if a UE is configured with downlink cells for which the UE is provided both monitoringCapabilityConfig=r15monitoringcapability and monitoringCapabilityConfig=r17monitoringcapability.

$${N}_{cells}^{cap}$$

is replaced by

$${N}_{cells , r 15 / \{ r 16 , r 17 \}}^{cap - r 17} ,$$

if a UE is configured with downlink cells for which the UE is provided both monitoringCapabilityConfig=r15monitoringcapability and monitoringCapabilityConfig=r16monitoringcapability and monitoringCapabilityConfig=r17monitoringcapability.

If a UE:
is configured with

$${N}_{cells , 0}^{D L , μ} + {N}_{cells , 1}^{D L , μ}$$

downlink cells for which the UE is not provided monitoringCapabilityConfig, or is provided monitoringCapabilityConfig=r15monitoringcapability and is not provided coresetPoolIndex,
with associated PDCCH candidates monitored in the active DL BWPs of the scheduling cell(s) using SCS configuration μ, where

$${\sum }_{μ = 0}^{3} ( {N}_{cells , 0}^{DL , μ} + γ \cdot {N}_{cells , 1}^{DL , μ} ) > {N}_{cells}^{cap} ,$$

and
a DL BWP of an activated cell is the active DL BWP of the activated cell, and a DL BWP of a deactivated cell is the DL BWP with index provided by firstActiveDownlinkBWP-Id for the deactivated cell,
   the UE is not required to monitor more than

$${M}_{PDCCH}^{total , slot , μ} = ⌊ {N}_{cells}^{cap} \cdot {M}_{PDCCH}^{max , slot , μ} \cdot ( {N}_{cells , 0}^{DL , μ} + γ \cdot {N}_{cells , 1}^{DL , μ} ) / {\sum }_{μ = 0}^{3} ( {N}_{cells , 0}^{DL , μ} + γ \cdot {N}_{cells , 1}^{DL , μ} ) ⌋$$

PDCCH candidates or more than

$${C}_{PDCCH}^{total , slot , μ} = ⌊ {N}_{cells}^{cap} \cdot {C}_{PDCCH}^{max , slot , μ} \cdot ( {N}_{cells , 0}^{DL , μ} + γ \cdot {N}_{cells , 1}^{DL , μ} ) / {\sum }_{μ = 0}^{3} ( {N}_{cells , 0}^{DL , μ} + γ \cdot {N}_{cells , 1}^{DL , μ} ) ⌋$$

non-overlapped CCEs per slot on the active DL BWP(s) of scheduling cell(s) from the

$${N}_{cells , 0}^{D L , μ} + {N}_{cells , 1}^{D L , μ}$$

downlink cells.

$${N}_{cells}^{cap}$$

is replaced by

$${N}_{cells , r 15}^{cap - r 16}$$

if a UE is configured with downlink cells for which the UE is provided both monitoringCapabilityConfig=r15monitoringcapability and monitoringCapabilityConfig=r16monitoringcapability.

$${N}_{cells}^{cap}$$

is replaced by

$${N}_{cells , r 15 / r 17}^{cap - r 17} ,$$

if a UE is configured with downlink cells for which the UE is provided both monitoringCapabilityConfig=r15monitoringcapability and monitoringCapabilityConfig=r17monitoringcapability.

$${N}_{cells}^{cap}$$

is replaced by

$${N}_{cells , r 15 / \{ r 16 , r 17 \}}^{cap - r 17} .$$

If a UE is configured with downlink cells for which the UE is provided monitoringCapabilityConfig=r15monitoringcapability and monitoringCapabilityConfig=r16monitoringcapability and monitoringCapabilityConfig=r17monitoringcapability.

For each scheduled cell from the

$${N}_{cells , 0}^{DL , μ}$$

downlink cells, the UE is not required to monitor on the active DL BWP with SCS configuration μ of the scheduling cell more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot.

For each scheduled cell from the

$${N}_{cells , 1}^{DL , μ}$$

downlink cells, the UE is not required to monitor on the active DL BWP with SCS configuration μ of the scheduling cell:
more than

$$min ( γ \cdot {M}_{PDCCH}^{max , slot , μ} , {M}_{PDCCH}^{total , slot , μ} )$$

PDCCH candidates or more than

$$min ( γ \cdot {C}_{PDCCH}^{max , slot , μ} , {C}_{PDCCH}^{total , slot , μ} )$$

non-overlapped CCEs per slot,
more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot for CORESETs with same coresetPoolIndex value.

If a UE is configured with

$${N}_{cells , r 16}^{DL , μ}$$

downlink cells for which the UE is provided monitoringCapabilityConfig=r16monitoringcapability and with associated PDCCH candidates monitored in the active DL BWPs of the scheduling cells using SCS configuration μ, and with

$${N}_{cells , r 16}^{DL , ( X , Y ) , μ}$$

of the

$${N}_{cells , r 16}^{DL , μ}$$

downlink cells using combination (X, Y) for PDCCH monitoring, where

$${\sum }_{μ = 0}^{1} {N}_{cells , r 16}^{DL , μ} \leq {N}_{cells}^{cell - r 16} ,$$

the UE is not required to monitor, on the active DL BWP of the scheduling cell, more than

$${M}_{PDCCH}^{total , ( X , Y ) , μ} = {M}_{PDCCH}^{max , ( X , Y ) , μ}$$

PDCCH candidates or more than

$${C}_{PDCCH}^{total , ( X , Y ) , μ} = {C}_{PDCCH}^{max , ( X , Y ) , μ}$$

non-overlapped CCEs per span for each scheduled cell when the scheduling cell is from the

$${N}_{cells , r 16}^{DL , ( X , Y ) , μ}$$

downlink cells. If a UE is configured with downlink cells for which the UE is provided both monitoringCapabilityConfig=r15monitoringcapability and monitoringCapabilityConfig=r16monitoringcapability,

$${N}_{cells}^{cap - r 16}$$

cells is replaced by

$${N}_{cells , r 16}^{cap - r 16} .$$

If a UE is configured with downlink cells for which the UE is provided both monitoringCapabilityConfig=r16monitoringcapability and monitoringCapabilityConfig=r17monitoringcapability,

$${N}_{cells}^{cap}$$

is replaced by

$${N}_{cells , r 16 / r 17}^{cap - r 17} .$$

If a UE is configured with downlink cells for which the UE is provided monitoringCapabilityConfig=r15monitoringcapability and monitoringCapabilityConfig=r16monitoringcapability and monitoringCapabilityConfig=r17monitoringcapability,

$${N}_{cells}^{cap}$$

is replaced by

$${N}_{cells , r 16 / \{ r 15 , r 17 \}}^{cap - r 17} .$$

If a UE is configured only with

$${N}_{cells , r 16}^{DL , μ}$$

downlink cells for which the UE is provided monitoringCapabilityConfig=r16monitoringcapability and with associated PDCCH candidates monitored in the active DL BWPs of the scheduling cells using SCS configuration μ, and with

$${N}_{cells , r 16}^{DL , ( X , Y ) , μ}$$

of the

$${N}_{cells , r 16}^{DL , μ}$$

downlink cells using combination (X, Y) for PDCCH monitoring, where

$${\sum }_{μ = 0}^{1} {N}_{cells , r 16}^{DL , μ} > {N}_{cells}^{cell - r 16} ,$$

a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , ( X , Y ) , μ} = ⌊ {N}_{cells}^{cap - r 16} \cdot {M}_{PDCCH}^{max , ( X , Y ) , μ} \cdot {N}_{cells , r 16}^{DL , ( X , Y ) μ} / {\sum }_{μ = 0}^{3} {N}_{cells , r 16}^{DL , j} ⌋$$

PDCCH candidates or more than

$${C}_{PDCCH}^{total , ( X , Y ) , μ} = ⌊ {N}_{cells}^{cap - r 16} \cdot {C}_{PDCCH}^{max , ( X , Y ) , μ} \cdot {N}_{cells ,}^{DL , ( X , Y ) , μ} / {\sum }_{j = 0}^{1} {N}_{cells , r 16}^{DL , j} ⌋$$

non-overlapped CCEs:
per set of spans on the active DL BWP(s) of all scheduling cell(s) from the

$${N}_{cells , r 16}^{DL , ( X , Y ) , μ}$$

downlink cells within every X symbols, if the union of PDCCH monitoring occasions on all scheduling cells from the

$${N}_{cells , r 16}^{DL , ( X , Y ) , μ}$$

downlink cells results to PDCCH monitoring according to the combination (X, Y) and any pair of spans in the set is within Y symbols, where first X symbols start at a first symbol with a PDCCH monitoring occasion and next X symbols start at a first symbol with a PDCCH monitoring occasion that is not included in the first X symbols,
per set of spans across the active DL BWP(s) of all scheduling cells from the

$${N}_{cells , r 16}^{DL , ( X , Y ) , μ}$$

downlink cells, with at most one span per scheduling cell for each set of spans, otherwise
   where

$${N}_{cells , r 16}^{DL , j}$$

is a number of configured cells with associated PDCCH candidates monitored in the active DL BWPs of the scheduling cells using SCS configuration j. If a UE is configured with downlink cells for which the UE is provided both monitoringCapabilityConfig=r15monitoringcapability and monitoringCapabilityConfig=r16monitoringcapability,

$${N}_{cells}^{cap - r16}$$

is replaced by

$${N}_{cells , r 16}^{cap - r16} .$$

If a UE is configured with downlink cells for which the UE is provided both monitoringCapabilityConfig=r16monitoringcapability and monitoringCapabilityConfig=r17monitoringcapability,

$${N}_{cells}^{cap}$$

is replaced by

$${N}_{cells , r 16 / r 17}^{cap - r 17} .$$

If a UE is configured with downlink cells for which the UE is provided monitoringCapabilityConfig=r15monitoringcapability and monitoringCapabilityConfig=r16monitoringcapability and monitoringCapabilityConfig=r17monitoringcapability,

$${N}_{cells}^{cap}$$

is replaced by

$${N}_{cells , r 16 / \{ r 15 , r 17 \}}^{cap - r 17} .$$

For each scheduled cell from the

$${N}_{cells , r 16}^{DL , ( X , Y ) , μ}$$

downlink cells using combination (X, Y), the UE is not required to monitor on the active DL BWP with SCS configuration μ of the scheduling cell, more than

$$min ( {M}_{PDCCH}^{max , ( X , Y ) , μ} , {M}_{PDCCH}^{total , ( X , Y ) , μ} )$$

PDCCH candidates or more than

$$min ( {C}_{PDCCH}^{max , ( X , Y ) , μ} , {C}_{PDCCH}^{total , ( X , Y ) , μ} )$$

non-overlapped CCEs per span.

A UE does not expect to be configured CSS sets, except for CSS sets provided by searchSpaceMCCH, searchSpaceMTCH, searchSpaceMulticastMCCH, searchSpaceMulticastMTCH or by SearchSpace in pdcch-ConfigMulticast for DCI formats with CRC scrambled by G-RNTI or G-CS-RNTI, that result to corresponding total, or per scheduled cell, numbers of monitored PDCCH candidates and non-overlapped CCEs per slot, per group of Xₛ slots for a corresponding combination (Xₛ, Yₛ), or per span that exceed the corresponding maximum numbers per slot, or per group of Xₛ slots for a corresponding combination (Xₛ, Yₛ), or per span, respectively.

For same cell scheduling or for cross-carrier scheduling, a UE does not expect a number of PDCCH candidates, and a number of corresponding non-overlapped CCEs per slot, or per group of Xₛ slots for a corresponding combination (Xₛ, Yₛ), or per span, on a secondary cell to be larger than the corresponding numbers that the UE is capable of monitoring on the secondary cell per slot, or per group of Xₛ slots for a corresponding combination (Xₛ, Yₛ), or per span, respectively. If a UE is provided monitoringCapabilityConfig=r16monitoringcapability for the primary cell, except the first span of each slot, the UE does not expect a number of PDCCH candidates and a number of corresponding non-overlapped CCEs per span on the primary cell to be larger than the corresponding numbers that the UE is capable of monitoring on the primary cell per span.

If a UE is configured with

$${N}_{cells , r 17 , 0}^{D L , μ} + {N}_{cells , r 17 , 1}^{D L , μ}$$

downlink cells for which the UE is provided monitoringCapabilityConfig=r17monitoringcapability and with associated PDCCH candidates monitored in the active DL BWPs of the scheduling cells using SCS configuration μ, and with

$${N}_{cells , r 17 , 0}^{D L , {X}_{s} , μ} + {N}_{cells , r 17 , 1}^{D L , {X}_{s} , μ} of the {N}_{cells , r 17 , 0}^{D L , μ} + {N}_{cells , r 17 , 1}^{D L , μ}$$

downlink cells using any combination (Xₛ, Yₛ) for a group of Xₛ slots for PDCCH monitoring, where

$${\sum }_{μ = 5}^{6} ( {N}_{cells , r 17 , 0}^{DL , μ} + γ \cdot {N}_{cells , r 17 , 1}^{DL , μ} ) \leq {N}_{cells}^{cap - r 17} ,$$

the UE is not required to monitor, on the active DL BWP of the scheduling cell,
more than

$${M}_{PDCCH}^{total , {X}_{s} , μ} = {M}_{PDCCH}^{max , {X}_{s} , μ}$$

PDCCH candidates or more than

$${C}_{PDCCH}^{total , {X}_{s} , μ} = {C}_{PDCCH}^{max , {X}_{s} , μ}$$

non-overlapped CCEs per group of Xₛ slots for each scheduled cell when the scheduling cell is from the

$${N}_{cells , r 17 , 0}^{D L , {X}_{s} , μ}$$

downlink cells, or
more than

$${M}_{PDCCH}^{total , {X}_{s} , μ} = γ \cdot {M}_{PDCCH}^{max , {X}_{s} , μ}$$

PDCCH candidates or more than

$${C}_{PDCCH}^{total , {X}_{s} , μ} = γ \cdot {C}_{PDCCH}^{max , {X}_{s} , μ}$$

non-overlapped CCEs per group of Xₛ slots for each scheduled cell when the scheduling cell is from the

$${N}_{cells , r 17 , 1}^{DL , {X}_{s} , μ}$$

downlink cells, or
more than

$${M}_{PDCCH}^{max , {X}_{s} , μ}$$

PDCCH candidates or more than

$${C}_{P D C C H}^{max , {X}_{s} , μ}$$

non-overlapped CCEs per group of Xₛ slots for CORESETs with same coresetPoolIndex for each scheduled cell when the scheduling cell is from the

$${N}_{cells , r 17 , 1}^{DL , {X}_{s} , μ}$$

downlink cells.

If the UE is configured with downlink cells for which the UE is provided monitoringCapabilityConfig=r15monitoringcapability and downlink cells for which the UE is provided monitoringCapabilityConfig=r17monitoringcapability for the active DL BWPs,

$${N}_{cells}^{cap - r 17}$$

is replaced by

$${N}_{cells , r 17 / r 15}^{cap - r 17} .$$

If the UE is configured with downlink cells for which the UE is provided monitoringCapabilityConfig=r16monitoringcapability and downlink cells for which the UE is provided monitoringCapabilityConfig=r17monitoringcapability for the active DL BWPs,

$${N}_{cells}^{cap - r 17}$$

is replaced by

$${N}_{cells , r 17 / r 16}^{cap - r 17} .$$

If the UE is configured with downlink cells for which the UE is provided monitoringCapabilityConfig=r15monitoringcapability and downlink cells for which the UE is provided monitoringCapabilityConfig=r16monitoringcapability and downlink cells for which the UE is provided monitoringCapabilityConfig=r17monitoringcapability for the active DL BWPs,

$${N}_{cells}^{cap - r 17}$$

is replaced by

$${N}_{cells , r 17 / \{ r 15 , r 16 \}}^{cap - r 17} .$$

If, for one or more of the cells, the UE is provided with monitoringCapabilityConfig=r16monitoringcapability, γ=1.

If a UE is configured

$${N}_{cells , r 17 , 0}^{D L , μ} + {N}_{cells , r 17 , 1}^{D L , μ}$$

downlink cells for which the UE is provided monitoringCapabilityConfig=r17monitoringcapability and with associated PDCCH candidates monitored in the active DL BWPs of the scheduling cells using SCS configuration μ, and with

$${N}_{cells , r 17 , 0}^{D L , {X}_{s} , μ} + {N}_{cells , r 17 , 1}^{D L , {X}_{s} μ} of the {N}_{cells , r 17 , 0}^{D L , μ} + {N}_{cells , r 17 , 1}^{D L , μ}$$

downlink cells using any combination (Xₛ, Yₛ) for a group of Xₛ slots for PDCCH monitoring, where

$${\sum }_{μ = 5}^{6} ( {N}_{cells , r 17 , 0}^{DL , μ} + γ \cdot {N}_{cells , r 17 , 1}^{DL , μ} ) > {N}_{cells}^{cap - r 17} ,$$

a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , {X}_{s} , μ} = ⌊ {N}_{cells}^{cap - r 17} \cdot {M}_{PDCCH}^{max , {X}_{s} , μ} \cdot ( {N}_{cells , r 17 , 0}^{DL , {X}_{s} , μ} + γ \cdot {N}_{cells , r 17 , 1}^{DL , {X}_{s} , μ} ) / {\sum }_{j = 5}^{6} ( {N}_{cells , r 17 , 0}^{DL , j} + γ \cdot {N}_{cells , r 17 , 1}^{DL , j} ) ⌋$$

PDCCH candidates, or more than

$${C}_{PDCCH}^{total , {X}_{s} , μ} = ⌊ {N}_{cells}^{cap - r 17} \cdot {C}_{PDCCH}^{max , {X}_{s} , μ} \cdot ( {N}_{cells , r 17 , 0}^{DL , {X}_{s ,} μ} + γ \cdot {N}_{cells , r 17 , 1}^{DL , {X}_{s} , μ} ) / {\sum }_{j = 5}^{6} ( {N}_{cells , r 17 , 0}^{DL , j} + γ \cdot {N}_{cells , r 17 , 1}^{DL , j} ) ⌋$$

non-overlapped CCEs, per group of Xₛ slots on the active DL BWP(s) of scheduling cell(s) from the

$${N}_{cells , r 17 , 0}^{D L , {X}_{s} , μ} + {N}_{cells , r 17 , 1}^{D L , {X}_{s} μ}$$

downlink cells where

$${N}_{cells , r 17 , 0}^{DL , j} + {N}_{cells , r 17 , 1}^{DL , j}$$

is a number of configured cells with associated PDCCH candidates monitored in the active DL BWPs of the scheduling cells using SCS configuration j.

If the UE is configured with downlink cells for which the UE is provided monitoringCapabilityConfig=r15monitoringcapability and downlink cells for which the UE is provided monitoringCapabilityConfig=r17monitoringcapability for the active DL BWPs,

$${N}_{cells}^{cap - r 17}$$

is replaced by

$${N}_{cells , r 17 / r 15}^{cap - r 17} .$$

If the UE is configured with downlink cells for which the UE is provided monitoringCapabilityConfig=r16monitoringcapability and downlink cells for which the UE is provided monitoringCapabilityConfig=r17monitoringcapability for the active DL BWPs.

$${N}_{cells}^{cap - r 17}$$

is replaced by

$${N}_{cells , r 17 / r 16}^{cap - r 17} .$$

If the UE is configured with downlink cells for which the UE is provided monitoringCapabilityConfig=r15monitoringcapability and downlink cells for which the UE is provided monitoringCapabilityConfig=r16monitoringcapability and downlink cells for which the UE is provided monitoringCapabilityConfig=r17monitoringcapability for the active DL BWPs,

$${N}_{cells}^{cap - r 17}$$

is replaced by

$${N}_{cells , r 17 / \{ r 15 , r 16 \}}^{cap - r 17} .$$

If, for one or more of the cells, the UE is provided with monitoringCapabilityConfig=r16monitoringcapability, γ=1.

For each scheduled cell from the

$${N}_{cells , r 17 , 0}^{DL , {X}_{s} , μ}$$

downlink cells using any combination (Xₛ, Yₛ) for a group of Xₛ slots, the UE is not required to monitor on the active DL BWP with SCS configuration μ of the scheduling cell, more than

$$min ( {M}_{P D C C H}^{{max X}_{s} , μ} , {M}_{P D C C H}^{total , {X}_{s} , μ} )$$

PDCCH candidates or more than

$$min ( {C}_{P D C C H}^{max , {X}_{s} , μ} , {C}_{P D C C H}^{total , {X}_{s} , μ} )$$

non-overlapped CCEs per group of Xₛ slots.

For each scheduled cell from the

$${N}_{cells , r 17 , 1}^{DL , {X}_{s} , μ}$$

downlink cells using any combination (Xₛ, Yₛ) for a group of Xₛ slots, the UE is not required to monitor on the active DL BWP with SCS configuration μ of the scheduling cell,
more than

$$min ( γ \cdot {M}_{P D C C H}^{max , {X}_{s} , μ} , {M}_{P D C C H}^{total , {X}_{s} , μ} )$$

PDCCH candidates or more than

$$min ( γ \cdot {C}_{P D C C H}^{max , {X}_{s} , μ} , {C}_{P D C C H}^{total , {X}_{s} , μ} )$$

non-overlapped CCEs per group of Xₛ slots,
more than

$$min ( {M}_{P D C C H}^{max , {X}_{s} , μ} , {M}_{P D C C H}^{total , {X}_{s} , μ} )$$

PDCCH candidates or more than

$$min ( {C}_{P D C C H}^{max , {X}_{s} , μ} , {C}_{P D C C H}^{total , {X}_{s} , μ} )$$

non-overlapped CCEs per group of Xₛ slots for CORESETs with the same coresetPoolIndex value.

For cross-carrier scheduling, the number of PDCCH candidates for monitoring and the number of non-overlapped CCEs per span or per slot or per group of Xₛ slots are separately counted for each scheduled cell.

The UE allocates PDCCH candidates for monitoring to USS sets for the primary cell having an active DL BWP with SCS configuration u in a slot if the UE is not provided monitoringCapabilityConfig for the primary cell or if the UE is provided monitoringCapabilityConfig=r15monitoringcapability for the primary cell, or in the first span of each slot if the UE is provided monitoringCapabilityConfig=r16monitoringcapability for the primary cell, or in a group of Xₛ slots for a corresponding combination (Xₛ, Yₛ) if the UE is provided monitoringCapabilityConfig=r17monitoringcapability for the primary cell, according to the following pseudocode.

If for the USS sets for scheduling on the primary cell the UE is not provided coresetPoolIndex for first CORESETs, or is provided coresetPoolIndex with value 0 for first CORESETs, and is provided coresetPoolIndex with value 1 for second CORESETs, and if

$$min ( γ \cdot {M}_{P D C C H}^{max , slot , μ} , {M}_{P D C C H}^{total , slot , μ} ) > min ( {M}_{P D C C H}^{max , slot , μ} , {M}_{P D C C H}^{total , slot , μ} ) or min ( γ \cdot {C}_{P D C C H}^{max , slot , μ} , {C}_{P D C C H}^{total , slot , μ} ) > min ( {C}_{P D C C H}^{max , slot , μ} , {C}_{P D C C H}^{total , slot , μ} ) ,$$

the following pseudocode applies only to USS sets associated with the first CORESETs. A UE does not expect to monitor PDCCH in a USS set without allocated PDCCH candidates for monitoring.

In the following pseudocode, if the UE is provided monitoringCapabilityConfig=r16monitoringcapability for the primary cell,

$${M}_{P D C C H}^{max , slot , μ} and {C}_{P D C C H}^{max , slot , μ}$$

are replaced by

$${M}_{P D C C H}^{max , ( X , Y ) , μ} and {C}_{P D C C H}^{max , ( X , Y ) , μ}$$

respectively, and

$${M}_{PDCCH}^{total , slot , μ} and {C}_{P D C C H}^{total , slot , μ}$$

are replaced by

$${M}_{P D C C H}^{total , ( X , Y ) , μ} and {C}_{P D C C H}^{total , ( X , Y ) , μ}$$

respectively.

In the following pseudocode, if the UE is provided monitoringCapabilityConfig=r17monitoringcapability for the primary cell,

$${M}_{PDCCH}^{max , slot , μ} and {C}_{PDCCH}^{max , slot , μ}$$

are replaced by

$${M}_{PDCCH}^{max , {X}_{s} , μ} and {C}_{P D C C H}^{max , {X}_{s} , μ}$$

respectively, and

$${M}_{PDCCH}^{total , slot , μ} and {C}_{PDCCH}^{total , slot , μ}$$

are replaced by

$${M}_{P D C C H}^{t otal , {X}_{s} , μ} and {C}_{P D C C H}^{t otal , {X}_{s} , μ}$$

respectively.

For all search space sets that a UE monitors PDCCH on the primary cell within a slot n, or within a group of Xₛ slots for a corresponding combination (Xₛ, Yₛ), or within a span in slot n, denote by S_{css} a set of CSS sets, except for CSS sets provided by searchSpaceMCCH, searchSpaceMTCH, searchSpaceMulticastMCCH, searchSpaceMulticastMICH or by SearchSpace in pdcch-ConfigMulticast for DCI formats with CRC scrambled by G-RNTI or G-CS-RNTI, with cardinality of I_{css} and by Sᵤₛₛ a set of USS sets and CSS sets provided by searchSpaceMCCH, searchSpaceMTCH or by SearchSpace in pdcch-ConfigMulticast for DCI formats with CRC scrambled by G-RNTI or G-CS-RNTI with cardinality of Jᵤₛₛ for scheduling on the primary cell. The location of search space sets sⱼ, 0≤j<Jᵤₛₛ, in Sᵤₛₛ is according to an ascending order of the search space set index.

Denote by

$${M}_{{S}_{c s s ( i )}}^{( L )} ,$$

the number of counted PDCCH candidates for monitoring for CSS set S_{css}(i) and by

$${M}_{{S}_{uss ( j )}}^{( L )} ,$$

0≤j<j<Jᵤₛₛ, the number of counted PDCCH candidates for monitoring for search space set Sᵤₛₛ(j). If a UE indicates numBD-twoPDCCH-r17 with value of 3 and is provided searchSpaceLinkingId with same value for search space sets sⱼ and sᵢ, with sᵢ<sⱼ, set

$${M}_{{S}_{c s s ( j )}}^{( L )} = 2 \cdot {M}_{{S}_{c s s ( j )}}^{( L )}$$

if sᵢ and sⱼ are CSS sets or set

$${M}_{{S}_{uss ( j )}}^{( L )} = 2 \cdot {M}_{{S}_{u s s ( j )}}^{( L )}$$

if sᵢ and sⱼ are USS sets.

For the CSS sets in S_{css}, a UE monitors

$${M}_{PDCCH}^{css} = {\sum }_{i = 0}^{{I}_{css} - 1} {\sum }_{L} {M}_{{S}_{css ( i )}}^{( L )}$$

PDCCH candidates requiring a total of

$${C}_{P D C C H}^{c s s}$$

non-overlapping CCEs in a slot, of in group of Xₛ slots for a corresponding combination (Xₛ, Yₛ), or in a span.

Denote by V_{CCE}(Sᵤₛₛ(j)) the set of non-overlapping CCEs for search space set Sᵤₛₛ(j) and by C(V_{CCE}(Sᵤₛₛ(j))); the cardinality of V_{CCE}(Sᵤₛₛ(j)) where a UE determines the non-overlapping CCEs for search space set Sᵤₛₛ(j) considering the allocated PDCCH candidates for monitoring for the CSS sets in S_{css} and the allocated PDCCH candidates for monitoring for all search space sets Sᵤₛₛ(k), 0≤k≤j.

### Set

$${M}_{PDCCH}^{uss} = min ( {M}_{PDCCH}^{max , slot , μ} , {M}_{PDCCH}^{total , slot , μ} ) - {M}_{PDCCH}^{css}$$

### Set

$${C}_{PDCCH}^{uss} = min ( {C}_{PDCCH}^{max , slot , μ} , {C}_{PDCCH}^{total , slot , μ} ) - {C}_{PDCCH}^{css}$$

Set j=0
while

$${\sum }_{L} {M}_{{S}_{uss} ( j )}^{( L )} \leq {M}_{PDCCH}^{uss} AND C ( {V}_{CCE} ( {S}_{uss} ( j ) ) ) \leq {C}_{PDCCH}^{uss}$$

allocate

$${\sum }_{L} {M}_{{S}_{uss} ( j )}^{( L )}$$

PDCCH candidates for monitoring to search space set Sᵤₛₛ(j)

$${M}_{PDCCH}^{uss} = {M}_{PDCCH}^{uss} - {\sum }_{L} {M}_{{S}_{uss} ( j )}^{( L )} ;$$

$${C}_{PDCCH}^{uss} = {C}_{PDCCH}^{uss} - C ( {V}_{CCE} ( {S}_{uss} ( j ) ) ) ;$$

$$j = j + 1 ;$$

end while

If a UE
is configured for single cell operation or for operation with carrier aggregation in a same frequency band, and
monitors PDCCH candidates in overlapping PDCCH monitoring occasions in multiple CORESETs that have been configured with same or different qcl-Type set to ‘typeD’ properties on active DL BWP(s) of one or more cells,
   the UE monitors PDCCHs only in a CORESET, and in any other CORESET from the multiple CORESETs that have been configured with qcl-Type set to same ‘typeD’ properties as the CORESET, on the active DL BWP of a cell from the one or more cells:
the CORESET corresponds to the CSS set with the lowest index in the cell with the lowest index containing CSS, if any; otherwise, to the USS set with the lowest index in the cell with lowest index
the lowest USS set index is determined over all USS sets with at least one PDCCH candidate in overlapping PDCCH monitoring occasions

If a UE:
is not provided coresetPoolIndex for first CORESETs, or is provided coresetPoolIndex with value 0 for first CORESETs, and
is provided coresetPoolIndex with value 1 for second CORESETs, and
is provided twoQCLTypeDforMulti-DCI,
   the UE applies the procedures in the above paragraph independently across the first CORESETs and the second CORESETs.

If a UE:
is configured for single cell operation or for operation with carrier aggregation in a same frequency band,
monitors PDCCH candidates in overlapping PDCCH monitoring occasions in multiple CORESETs that have been configured with same or different qcl-Type set to ‘typeD’ properties on active DL BWP(s) of one or more cells, and
is provided twoQCLTypeDforPDCCHRepetition,
   the UE monitors PDCCHs only in a first CORESET with qcl-Type set to first ‘typeD’ properties and, if any, in a second CORESET with qcl-Type set to second ‘typeD’ properties that are different than the first ‘typeD’ properties, and in any other CORESET from the multiple CORESETs with corresponding qcl-Type set to either the first ‘typeD’ properties or to the second ‘typeD’ properties:
the first CORESET corresponds to the CSS set with the lowest index in the cell with the lowest index containing CSS sets, if any; otherwise, to the USS set with the lowest index in the cell with lowest index,
excluding CSS sets and USS sets associated with CORESETs with qcl-Type set to first ‘typeD’ properties, the second CORESET corresponds to the CSS set with the lowest index in the cell with the lowest index containing CSS sets, if any; otherwise, to the USS set with the lowest index in the cell with lowest index, where the CSS set or the USS set includes searchSpaceLinkingId with same value as any CSS set or any USS set associated with CORESETs with qcl-Type set to first ‘typeD’ properties,
the lowest USS set index is determined over all USS sets with at least one PDCCH candidate in overlapping PDCCH monitoring occasions.

If a UE:
is configured for single cell operation or for operation with carrier aggregation in a same frequency band,
monitors PDCCH candidates in overlapping PDCCH monitoring occasions in multiple CORESETs that have been configured with same or different qcl-Type set to ‘typeD’ properties on active DL BWP(s) of one or more cells,
one or more CORESETs have two activated TCI states, and
reports sfn-QCL-TypeD-Collision-twoTCI,
   the UE monitors PDCCHs only in a CORESET with a first qcl-Type set to first ‘typeD’ properties and, if any, a second qcl-Type set to second ‘typeD’ properties that are different than the first ‘typeD’ properties, and in any other CORESET from the multiple CORESETs with corresponding qcl-Type set to the first ‘typeD’ properties and/or to the second ‘typeD’ properties:
the CORESET corresponds to the CSS set with the lowest index in the cell with the lowest index containing CSS, if any; otherwise, to the USS set with the lowest index in the cell with lowest index,
the lowest USS set index is determined over all USS sets with at least one PDCCH candidate in overlapping PDCCH monitoring occasions.

For the purpose of determining the CORESET, a SS/PBCH block is considered to have different QCL ‘typeD’ properties than a CSI-RS.

For the purpose of determining the CORESET, a first CSI-RS associated with a SS/PBCH block in a first cell and a second CSI-RS in a second cell that is also associated with the SS/PBCH block are assumed to have same QCL ‘typeD’ properties.

The allocation of non-overlapping CCEs and of PDCCH candidates for PDCCH monitoring is according to all search space sets associated with the multiple CORESETs on the active DL BWP(s) of the one or more cells.

The number of active TCI states is determined from the multiple CORESETs.

If a UE
is configured for single cell operation or for operation with carrier aggregation in a same frequency band, and
monitors PDCCH candidates in overlapping PDCCH monitoring occasions in multiple CORESETs where none of the CORESETs has TCI-states configured with qcl-Type set to ‘typeD’,
   the UE is required to monitor PDCCH candidates in overlapping PDCCH monitoring occasions for search space sets associated with different CORESETs.

For a scheduled cell and at any time, if a UE is provided a C-RNTI, the UE expects to have received at most 16 PDCCHs for DCI formats with CRC scrambled by C-RNTI, CS-RNTI, MCS-C-RNTI, G-RNTI for multicast, or G-CS-RNTI scheduling 16 PDSCH receptions for which the UE has not received any corresponding PDSCH symbol and at most 16 PDCCHs for DCI formats with CRC scrambled by C-RNTI, CS-RNTI, or MCS-C-RNTI scheduling 16 PUSCH transmissions for which the UE has not transmitted any corresponding PUSCH symbol.

If a UE is not provided monitoringCapabilityConfig=r16monitoringcapability for any serving cell, and
is not configured for NR-DC operation and indicates through pdcch-BlindDetectionCA a capability to monitor PDCCH candidates for

$${N}_{cells}^{cap} \geq 4$$

downlink cells and the UE is configured with

$${N}_{cells}^{DL} > 4$$

downlink cells or

$${N}_{cells}^{UL} > 4$$

uplink cells, or
is configured with NR-DC operation and for a cell group with

$${N}_{cells}^{D L}$$

downlink cells or

$${N}_{cells}^{UL}$$

uplink cells,
   the UE expects to have respectively received at most

$$16 \cdot {N}_{cells}^{c a p}$$

### PDCCHs for

DCI formats with CRC scrambled by a C-RNTI, or a CS-RNTI, or a MCS-C-RNTI, or a G-RNTI for multicast, or a G-CS-RNTI scheduling

$$16 \cdot {N}_{cells}^{c a p}$$

PDSCH receptions for which the UE has not received any corresponding PDSCH symbol over all

$${N}_{cells}^{D L}$$

downlink cells,
DCI formats with CRC scrambled by a C-RNTI, or a CS-RNTI, or a MCS-C-RNTI scheduling

$$16 \cdot {N}_{cells}^{c a p}$$

PUSCH transmissions for which the UE has not transmitted any corresponding PUSCH symbol over all

$${N}_{cells}^{UL}$$

uplink cells.

If a UE is provided monitoringCapabilityConfig=r16monitoringcapability for all serving cells, and
is not configured for NR-DC operation and indicates through pdcch-MonitoringCA a capability to monitor PDCCH candidates for

$${N}_{cells}^{cap - r 16} \geq 2$$

downlink cells and the UE is configured with

$${N}_{cells}^{D L} > 2$$

downlink cells or

$${N}_{cells}^{UL} > 2$$

uplink cells, or
is configured with NR-DC operation and for a cell group with

$${N}_{cells}^{D L}$$

downlink cells or

$${N}_{cells}^{UL}$$

uplink cells
   the UE expects to have respectively received at most

$$16 \cdot {N}_{cells}^{cap - r 16}$$

### PDCCHs for

DCI formats with CRC scrambled by a C-RNTI, or a CS-RNTI, or a MCS-C-RNTI, or a G-RNTI for multicast, or a G-CS-RNTI scheduling

$$16 \cdot {N}_{cells}^{cap - r 16}$$

PDSCH receptions for which the UE has not received any corresponding PDSCH symbol over all

$${N}_{cells}^{D L}$$

downlink cells,
DCI formats with CRC scrambled by a C-RNTI, or a CS-RNTI, or a MCS-C-RNTI scheduling

$$16 \cdot {N}_{cells}^{cap - r 16}$$

PUSCH transmissions for which the UE has not transmitted any corresponding PUSCH symbol over all

$${N}_{cells}^{UL}$$

uplink cells.

If a UE is provided monitoringCapabilityConfig=r16monitoringcapability for at least one serving cell and is not provided monitoringCapabilityConfig=r16monitoringcapability for at least one serving cell, and
is not configured for NR-DC operation, and indicates a capability to monitor PDCCH candidates for

$${N}_{cells , r 15}^{cap - r 16} \geq 1$$

downlink cells and

$${N}_{cells , r 16}^{cap - r 16} \geq 1$$

downlink cells, and the UE is configured with

$${N}_{cells}^{DL} > 1$$

downlink cells or

$${N}_{cells}^{UL} > 1$$

uplink cells, or
is configured with NR-DC operation and for a cell group with

$${N}_{cells}^{DL}$$

downlink cells or

$${N}_{cells}^{UL}$$

uplink cells,
   the UE expects to have respectively received
at most

$$16 \cdot {N}_{cells , r 15}^{cap - r 16}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 15}^{cap - r 16}$$

PDSCH receptions for which the UE has not received any corresponding PDSCH symbol over all serving cells that are not provided monitoringCapabilityConfig=r16monitoringcapability,
at most

$$16 \cdot {N}_{cells , r 15}^{cap - r 16}$$

PDCCHs for DCI formats with CRC scrambled by a C-RNTI, or a CS-RNTI, or a MCS-C-RNTI scheduling

$$16 \cdot {N}_{cells , r 15}^{cap - r 16}$$

PUSCH transmissions for which the UE has not transmitted any corresponding PUSCH symbol over all serving cells that are not provided monitoringCapabilityConfig=r16monitoringcapability,
at most

$$16 \cdot {N}_{cells , r 16}^{cap - r 16}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 16}^{cap - r 16}$$

PDSCH receptions for which the UE has not received any corresponding PDSCH symbol over all serving cells that are provided monitoringCapabilityConfig=r16monitoringcapability
at most

$$16 \cdot {N}_{cells , r 16}^{cap - r 16}$$

PDCCHs for DCI formats with CRC scrambled by a C-RNTI, or a CS-RNTI, or a MCS-C-RNTI scheduling

$$16 \cdot {N}_{cells , r 16}^{cap - r 16}$$

PUSCH transmissions for which the UE has not transmitted any corresponding PUSCH symbol over all serving cells that are provided monitoringCapabilityConfig=r16monitoringcapability.

If a UE is provided serving cells with SCS configuration μ∈{5, 6} for the active DL BWP, is not configured for NR-DC operation and indicates through pdcch-MonitoringCA a capability to monitor PDCCH candidates for

$${N}_{cells}^{cap - r 17} \geq 4$$

downlink cells and the UE is configured with

$${N}_{cells}^{DL} > 4$$

downlink cells or

$${N}_{cells}^{UL} > 4$$

uplink cells, the UE expects to have respectively received at most

$$16 \cdot {N}_{cells}^{cap - r 17}$$

DCCHs for
DCI formats with CRC scrambled by a C-RNTI, or a CS-RNTI, or a MCS-C-RNTI, or a G-RNTI for multicast, or a G-CS-RNTI scheduling

$$16 \cdot {N}_{cells}^{cap - r 17}$$

PDSCH receptions for which the UE has not received any corresponding PDSCH symbol over all N_{cells}^{DL} downlink cells,
DCI formats with CRC scrambled by a C-RNTI, or a CS-RNTI, or a MCS-C-RNTI scheduling

$$16 \cdot {N}_{cells}^{cap - r 17}$$

PUSCH transmissions for which the UE has not transmitted any corresponding PUSCH symbol over all

$${N}_{cells}^{UL}$$

uplink cells.

If a UE is provided monitoringCapabilityConfig=r17monitoringcapability for at least one serving cell, is provided monitoringCapabilityConfig=r15monitoringcapability for at least one serving cell, is not provided monitoringCapabilityConfig=r16monitoringcapability for any serving cell, is not configured for NR-DC operation, indicates a capability to monitor PDCCH candidates for

$${N}_{cells , r 15 / r 17}^{cap - r 17} \geq 1$$

downlink cells and

$${N}_{cells , r 17 / r 15}^{cap - r 17} \geq 1$$

downlink cells, and UE is configured with

$${N}_{cells}^{DL} > 1$$

downlink cell or

$${N}_{cells}^{UL} > 1$$

uplink cells, the UE expects to have respectively received
at most

$$16 \cdot {N}_{cells , r 15 / r 17}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 15 / r 17}^{cap - r 17}$$

PDSCH receptions for which the UE has not received any corresponding PDSCH symbol over all serving cells that are provided monitoringCapabilityConfig=r15monitoringcapability,
at most

$$16 \cdot {N}_{cells , r 15 / r 17}^{cap - r 17}$$

PDCCHs for DCI formats with CRC scrambled by a C-RNTI, or a CS-RNTI, or a MCS-C-RNTI scheduling

$$16 \cdot {N}_{cells , r 15 / r 17}^{cap - r 17}$$

PUSCH transmissions for which the UE has not transmitted any corresponding PUSCH symbol over all serving cells that are provided monitoringCapabilityConfig=r15monitoringcapability,
at most

$$16 \cdot {N}_{cells , r 17 / r 15}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 17 / r 15}^{cap - r 17}$$

PDSCH receptions for which the UE has not received any corresponding PDSCH symbol over all serving cells with monitoringCapabilityConfig=r17monitoringcapability,
at most

$$16 \cdot {N}_{cells , r 17 / r 15}^{cap - r 17}$$

PDCCHs for DCI formats with CRC scrambled by a C-RNTI, or a CS-RNTI, or a MCS-C-RNTI scheduling

$$16 \cdot {N}_{cells , r 17 / r 15}^{cap - r 17}$$

PUSCH transmissions for which the UE has not transmitted any corresponding PUSCH symbol over all serving cells with monitoringCapabilityConfig=r17monitoringcapability.

If a UE is provided monitoringCapabilityConfig=r17monitoringcapability for at least one serving cell, is provided monitoringCapabilityConfig=r16monitoringcapability for at least one serving cell, is not provided monitoringCapabilityConfig=r15monitoringcapability for any serving cell, is not configured for NR-DC operation, indicates a capability to monitor PDCCH candidates for

$${N}_{cells , r 16 / r 17}^{cap - r 17} \geq 1$$

downlink cells and

$${N}_{cells , r 16 / r 17}^{cap - r 17} \geq 1$$

downlink cells, and the UE is configured with

$${N}_{cells}^{DL} > 1$$

downlink cells or

$${N}_{cells}^{UL} > 1$$

uplink cells, the UE expects to have respectively received:
at most

$$16 \cdot {N}_{cells , r 16 / r 17}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 16 / r 17}^{cap - r 17}$$

PDSCH receptions for which the UE has not received any corresponding PDSCH symbol over all serving cells that are provided monitoringCapabilityConfig=r16monitoringcapability,
at most

$$16 \cdot {N}_{cells , r 16 / r 17}^{cap - r 17}$$

PDCCHs for DCI formats with CRC scrambled by a C-RNTI, or a CS-RNTI, or a MCS-C-RNTI scheduling

$$16 \cdot {N}_{cells , r 16 / r 17}^{cap - r 17}$$

PUSCH transmissions for which the UE has not transmitted any corresponding PUSCH symbol over all serving cells that are provided monitoringCapabilityConfig=r16monitoringcapability,
at most

$$16 \cdot {N}_{cells , r 17 / r 16}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 17 / r 16}^{cap - r 17}$$

PDSCH receptions for which the UE has not received any corresponding PDSCH symbol over all serving cells with monitoringCapabilityConfig=r17monitoringcapability,
at most

$$16 \cdot {N}_{cells , r 17 / r 16}^{cap - r 17}$$

PDCCHs for DCI formats with CRC scrambled by a C-RNTI, or a CS-RNTI, or a MCS-C-RNTI scheduling

$$16 \cdot {N}_{cells , r 17 / r 16}^{cap - r 17}$$

PUSCH transmissions for which the UE has not transmitted any corresponding PUSCH symbol over all serving cells with monitoringCapabilityConfig=r17monitoringcapability.

If a UE is provided monitoringCapabilityConfig=r17monitoringcapability for at least one serving cell, is provided monitoringCapabilityConfig=r16monitoringcapability for at least one serving cell, and monitoringCapabilityConfig=r15monitoringcapability for at least one serving cell, is not configured for NR-DC operation, indicates a capability to monitor PDCCH candidates for

$${N}_{cells , r 15 / \{ r 16 , r 17 \}}^{cap - r 17} \geq 1$$

downlink cells,

$${N}_{cells , r 16 / \{ r 15 , r 17 \}}^{cap - r 17} \geq 1 , and {N}_{cells , r 17 / \{ r 15 , r 16 \}}^{cap - r 17} \geq 1$$

downlink cells, and is configured with

$${N}_{cells}^{DL} > 1$$

downlink cells or

$${N}_{cells}^{UL} > 1$$

uplink cells, the UE expects to have respectively received:
at most

$$16 \cdot {N}_{cells , r 15 / \{ r 16 , r 17 \}}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 15 / \{ r 16 , r 17 \}}^{cap - r 17}$$

PDSCH receptions for which the UE has not received any corresponding PDSCH symbol over all serving cells that are provided monitoringCapabilityConfig=r15monitoringcapability,
at most

$$16 \cdot {N}_{cells , r 15 / \{ r 16 , r 17 \}}^{cap - r 17}$$

PDCCHs for DCI formats with CRC scrambled by a C-RNTI, or a CS-RNTI, or a MCS-C-RNTI scheduling

$$16 \cdot {N}_{cells , r 15 / \{ r 16 , r 17 \}}^{cap - r 17}$$

PUSCH transmissions for which the UE has not transmitted any corresponding PUSCH symbol over all serving cells that are provided monitoringCapabilityConfig=r15monitoringcapability,
at most

$$16 \cdot {N}_{cells , r 16 / \{ r 15 , r 17 \}}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 16 / \{ r 15 , r 17 \}}^{cap - r 17}$$

PDSCH receptions for which the UE has not received any corresponding PDSCH symbol over all serving cells that are provided monitoringCapabilityConfig=r16monitoringcapability,
at most

$$16 \cdot {N}_{cells , r 16 / \{ r 15 , r 17 \}}^{cap - r 17}$$

PDCCHs for DCI formats with CRC scrambled by a C-RNTI, or a CS-RNTI, or a MCS-C-RNTI scheduling

$$16 \cdot {N}_{cells , r 16 / \{ r 15 , r 17 \}}^{cap - r 17}$$

PUSCH transmissions for which the UE has not transmitted any corresponding PUSCH symbol over all serving cells that are provided monitoringCapabilityConfig=r16monitoringcapability,
at most

$$16 \cdot {N}_{cells , r 17 / \{ r 16 , r 17 \}}^{cap - r 17}$$

PDCCHs for DCI formats with CRC scrambled by a C-RNTI, or a CS-RNTI, or a MCS-C-RNTI, or a G-RNTI for multicast, or a G-CS-RNTI scheduling

$$16 \cdot {N}_{cells , r 17 / \{ r 16 , r 17 \}}^{cap - r 17}$$

PDSCH receptions for which the UE has not received any corresponding PDSCH symbol over all serving cells with monitoringCapabilityConfig=r17monitoringcapability,
at most

$$16 \cdot {N}_{cells , r 17 / \{ r 16 , r 17 \}}^{cap - r 17}$$

PDCCHs for DCI formats with CRC scrambled by a C-RNTI, or a CS-RNTI, or a MCS-C-RNTI scheduling

$$16 \cdot {N}_{cells , r 17 / \{ r 16 , r 17 \}}^{cap - r 17}$$

PUSCH transmissions for which the UE has not transmitted any corresponding PUSCH symbol over all serving cells with monitoringCapabilityConfig=r17monitoringcapability.

If a UE
is configured to monitor a first PDCCH candidate for a DCI format 0_0 and a DCI format 1_0 from a CSS set and a second PDCCH candidate for a DCI format 0_0 and a DCI format 1_0 from a USS set, where the CSS set and the USS set do not include searchSpace LinkingId, in a CORESET with index zero on an active DL BWP, and
the DCI formats 0_0/1_0 associated with the first PDCCH candidate and the DCI formats 0_0/1_0 associated with the second PDCCH candidate have same size, and
the UE receives the first PDCCH candidate and the second PDCCH candidate over a same set of CCEs, and
the first PDCCH candidate and the second PDCCH candidate have identical scrambling, and
the DCI formats 0_0/1_0 for the first PDCCH candidate and the DCI formats 0_0/1_0 for the second PDCCH candidate have CRC scrambled by either C-RNTI, or MCS-C-RNTI, or CS-RNTI,
   the UE decodes only the DCI formats 0_0/1_0 associated with the first PDCCH candidate.

If a UE detects a DCI format with inconsistent information, the UE discards all the information in the DCI format.

A UE configured with a bandwidth part indicator in a DCI format determines, in case of an active DL BWP or of an active UL BWP change, that the information in the DCI format is applicable to the new active DL BWP or UL BWP, respectively, as described in clause 12.

For unpaired spectrum operation, if a UE is not configured for PUSCH/PUCCH transmission on serving cell c₂, the UE does not expect to monitor PDCCH on serving cell c₁ if the PDCCH overlaps in time with SRS transmission (including any interruption due to uplink or downlink RF retuning time [10, TS 38.133]) on serving cell c₂ and if the UE is not capable of simultaneous reception and transmission on serving cell c₁ and serving cell c₂.

If a UE is provided resourceBlocks and symbolsInResourceBlock in RateMatchPattern, or if the UE is additionally provided periodicityAndPattern in RateMatchPattern, the UE can determine a set of RBs in symbols of a slot that are not available for PDSCH reception scheduled by a DCI format as described in [6, TS 38.214]. If a PDCCH candidate that provides a DCI format is mapped to one or more REs that overlap with REs of any RB in the set of RBs in symbols of the slot, the UE does not expect to monitor the PDCCH candidate.

A UE does not expect to be configured with dci-FormatsSL and dci-FormatsExt in a same USS.

The following describes UE procedures for search space set group switching and skipping of PDCCH monitoring.

A UE can be provided:
a group index for a respective Type3-PDCCH CSS set or USS set by searchSpaceGroupIdList for PDCCH monitoring on a serving cell,
a group index for a respective Type3-PDCCH CSS set or USS set by searchSpaceGroupIdList-r17 for PDCCH monitoring on an active DL BWP of a serving cell.

If the UE is not provided searchSpaceGroupIdList or searchSpaceGroupIdList-r17 for a search space set, the following procedures that are based on search space set group switching are not applicable for PDCCH monitoring according to the search space set.

A UE can be provided a set of durations by pdcch-SkippingDurationList for Type3-PDCCH CSS set or USS set for PDCCH monitoring on an active DL BWP of a serving cell. If the UE is not provided pdcch-SkippingDurationList, the following procedures related to skipping of PDCCH monitoring are not applicable.

If a UE is provided cellGroupsForSwitchList, indicating one or more groups of serving cells, the following procedures apply to all serving cells within each group; otherwise, the following procedures apply only to a serving cell for which the UE is provided searchSpaceGroupIdList.

When a UE is provided searchSpaceGroupIdList or searchSpaceGroupIdList-r17, the UE resets PDCCH monitoring according to search space sets with group index 0, if provided by searchSpaceGroupIdList or searchSpaceGroupIdList-r17.

A UE can be provided by searchSpaceSwitchDelay or searchSpaceSwitchDelay-r17 a number of symbols P_{switch} where a minimum value of P_{switch} is provided in Table 1-4 for UE processing capability 1 and UE processing capability 2 and SCS configuration μ. UE processing capability 1 for SCS configuration u applies unless the UE indicates support for UE processing capability 2.

TABLE 1-4
Minimum value of P_{switch} [symbols]

| | Minimum P_{switch} value | Minimum P_{switch} value |
|---|---|---|
| | for UE processing | for UE processing |
| μ | capability 1 [symbols] | capability 2 [symbols] |
| 0 | 25 | 10 |
| 1 | 25 | 12 |
| 2 | 25 | 22 |
| 3 | 40 | — |
| 5 | 160 | — |
| 6 | 320 | — |

A UE can be provided, by searchSpaceSwitchTimer, a timer value for a serving cell that the UE is provided searchSpaceGroupIdList or, if provided, for a set of serving cells provided by cellGroupsForSwitchList. The UE decrements the timer value by one after each slot based on a reference SCS configuration that is the smallest SCS configuration u among all configured DL BWPs in the serving cell, or in the set of serving cells. The UE maintains the reference SCS configuration during the timer decrement procedure.

If a UE is provided by SearchSpaceSwitchTrigger a location of a search space set group switching flag field in a DCI format 2_0, as described in clause 11.1.1, for a serving cell where the UE has active DL BWP with SCS configuration u
if the UE detects a DCI format 2_0 and a value of the search space set group switching flag field in the DCI format 2_0 is 0, the UE starts monitoring PDCCH according to search space sets with group index 0, and stops monitoring PDCCH according to search space sets with group index 1, for the serving cell,
at the beginning of the first slot that is at least P_{switch} symbols after the last symbol of the PDCCH with the DCI format 2_0 when μ∈{0, 1, 2, 3},
at the beginning of the first slot, of a group of Xₛ slots, that is at least P_{switch} symbols after the last symbol of the PDCCH with the DCI format 2_0 when μ∈{5, 6},
if the UE detects a DCI format 2_0 and a value of the search space set group switching flag field in the DCI format 2_0 is 1, the UE starts monitoring PDCCH according to search space sets with group index 1, and stops monitoring PDCCH according to search space sets with group index 0, for the serving cell,
at the beginning of the first slot that is at least P_{switch} symbols after the last symbol of the PDCCH with the DCI format 2_0, when μ∈{0, 1, 2, 3},
at the beginning of the first slot, of a group of Xₛ slots, that is at least P_{switch} symbols after the last symbol of the PDCCH with the DCI format 2_0 when μ∈{5, 6},
   and the UE sets the timer value to the value provided by searchSpaceSwitchTimer
if the UE monitors PDCCH for a serving cell according to search space sets with group index 1, the UE starts monitoring PDCCH for the serving cell according to search space sets with group index 0, and stops monitoring PDCCH according to search space sets with group index 1, for the serving cell,
at the beginning of the first slot that is at least P_{switch} symbols after a slot where the timer expires or after a last symbol of a remaining channel occupancy duration for the serving cell if indicated by DCI format 2_0 when μ∈{0, 1, 2, 3},
at the beginning of the first slot, of a group of Xₛ slots, that is at least P_{switch} symbols after a slot where the timer expires or after a last symbol of a remaining channel occupancy duration for the serving cell if indicated by DCI format 2_0 when μ∈{5, 6}.

If a UE is provided searchSpaceGroupIdList and is not provided SearchSpaceSwitchTrigger for a serving cell,
if the UE detects a DCI format by monitoring PDCCH according to a search space set with group index 0, the UE starts monitoring PDCCH according to search space sets with group index 1, and stops monitoring PDCCH according to search space sets with group index 0, for the serving cell
   at the beginning of the first slot that is at least P_{switch} symbols after the last symbol of the PDCCH with the DCI format when μ∈{0, 1, 2, 3},
   at the beginning of the first slot, of a group of Xₛ slots, that is at least P_{switch} symbols after the last symbol of the PDCCH with the DCI format when μ∈{5, 6},
      the UE sets the timer value to the value provided by searchSpaceSwitchTimer if the UE detects a DCI format by monitoring PDCCH in any search space set,
if the UE monitors PDCCH for a serving cell according to search space sets with group index 1, the UE starts monitoring PDCCH for the serving cell according to search space sets with group index 0, and stops monitoring PDCCH according to search space sets with group index 1, for the serving cell
   at the beginning of the first slot that is at least P_{switch} symbols after a slot where the timer expires or, if the UE is provided a search space set to monitor PDCCH for detecting a DCI format 2_0, after a last symbol of a remaining channel occupancy duration for the serving cell if indicated by DCI format 2_0 when μ∈{0, 1, 2, 3},
   at the beginning of the first slot, of a group of Xₛ slots, that is at least P_{switch} symbols after a slot where the timer expires or, if the UE is provided a search space set to monitor PDCCH for detecting a DCI format 2_0, after a last symbol of a remaining channel occupancy duration for the serving cell if indicated by DCI format 2_0 when μ∈{5, 6}.

A UE determines a slot and a symbol in the slot to start or stop PDCCH monitoring according to search space sets for a serving cell that the UE is provided searchSpaceGroupIdList or, if cellGroupsForSwitchList is provided, for a set of serving cells, based on the largest Xₛ if the SCS configuration μ among all configured DL BWPs in the set of serving cells equals to 6, otherwise, based on the smallest SCS configuration u among all configured DL BWPs in the serving cell or in the set of serving cells and, if any, in the serving cell where the UE receives a PDCCH and detects a corresponding DCI format 2_0 triggering the start or stop of PDCCH monitoring according to search space sets.

A UE can be provided a set of durations by pdcch-SkippingDurationList for PDCCH monitoring on an active DL BWP of a serving cell and, if the UE is not provided searchSpaceGroupIdList-r17 on the active DL BWP of the serving cell, a DCI format 0_1/0_2/0_3 that schedules PUSCH transmission, and a DCI format 1_1/1_2/1_3 that schedules PDSCH reception, can include a PDCCH monitoring adaptation field of 1 bit or of 2 bits.

If the field has 1 bit and for PDCCH monitoring by the UE according to Type3-PDCCH CSS sets or USS sets on the active DL BWP of the serving cell
a ‘0’ value for the bit indicates no skipping in PDCCH monitoring,
a ‘1’ value for the bit indicates skipping PDCCH monitoring for a duration provided by the first value in the set of durations.

If the field has 2 bits and for PDCCH monitoring by the UE according to Type3-PDCCH CSS sets or USS sets on the active DL BWP of the serving cell,
a ‘00’ value for the bits indicates no skipping in PDCCH monitoring,
a ‘01’ value for the bits indicates skipping PDCCH monitoring for a duration provided by the first value in the set of durations,
a ‘10’ value for the bits indicates skipping PDCCH monitoring for a duration provided by the second value in the set of durations,
a ‘11’ value for the bits indicates skipping PDCCH monitoring for a duration provided by the third value in the set of durations, if any; otherwise, if the set of durations includes two values, a use of the ‘11’ value is reserved.

A UE can be provided group indexes for a Type3-PDCCH CSS set or USS set by searchSpaceGroupIdList-r17 for PDCCH monitoring on an active DL BWP of a serving cell and, if the UE is not provided pdcch-SkippingDurationList for the active DL BWP of the serving cell, a DCI format 0_1/0_2/0_3 that schedules PUSCH transmission, and a DCI format 1_1/1_2/1_3 that schedules PDSCH reception, can include a PDCCH monitoring adaptation field of 1 bit or of 2 bits for the serving cell.

If the field has 1 bit and for PDCCH monitoring by the UE according to Type3-PDCCH CSS sets or USS sets on the active DL BWP of the serving cell
a ‘0’ value for the bit indicates start of PDCCH monitoring according to search space sets with group index 0 and stop of PDCCH monitoring according to search space sets with other group indexes, if any,
a ‘1’ value for the bit indicates start of PDCCH monitoring according to search space sets with group index 1 and stop of PDCCH monitoring according to search space sets with other group indexes, if any, and the UE sets the timer value to the one provided by searchSpaceSwitchTimer-r17, if provided.

If the field has 2 bits and for PDCCH monitoring by the UE according to Type3-PDCCH CSS sets or USS sets on the active DL BWP of the serving cell
a ‘00’ value for the bit indicates start of PDCCH monitoring according to search space sets with group index 0 and stop of PDCCH monitoring according to search space sets with other group indexes, if any,
a ‘01’ value for the bit indicates start of PDCCH monitoring according to search space sets with group index 1 and stop of PDCCH monitoring according to search space sets with other group indexes, if any, and the UE sets the timer value to the one provided by searchSpaceSwitchTimer-r17, if provided,
a ‘10’ value for the bit indicates start of PDCCH monitoring according to search space sets with group index 2 and stop of PDCCH monitoring according to search space sets with other group indexes, if any, and the UE sets the timer value to the one provided by searchSpaceSwitchTimer-r17, if provided,
a ‘11’ value is reserved.

A UE can be provided a set of durations by pdcch-SkippingDurationList and group indexes for a Type3-PDCCH CSS set or USS set by searchSpaceGroupIdList-r17 for PDCCH monitoring on an active DL BWP of a serving cell and, a DCI format 0_1/0_2/0_3 that schedules PUSCH transmission, and a DCI format 1_1/1_2/1_3 that schedules PDSCH reception, can include a PDCCH monitoring adaptation field of 2 bits.

If the set of durations includes one value and for PDCCH monitoring by the UE according to Type3-PDCCH CSS sets or USS sets on the active DL BWP of the serving cell
a ‘00’ value for the bits indicates start of PDCCH monitoring according to search space sets with group index 0 and stop of PDCCH monitoring according to search space sets with group index 1, if any,
a ‘01’ value for the bits indicates start of PDCCH monitoring according to search space sets with group index 1 and stop of PDCCH monitoring according to search space sets with group index 0, if any, and the UE sets the timer value to the one provided by searchSpaceSwitchTimer-r17, if provided,
a ‘10’ value for the bits indicates skipping PDCCH monitoring for a duration provided by the value in the set of durations,
a ‘11’ value is reserved.

If the set of durations includes two values and for PDCCH monitoring by the UE according

to Type3-PDCCH CSS sets or USS sets on active DL BWP of the serving cell
a ‘00’ value for the bits indicates start of PDCCH monitoring according to search space sets with group index 0 and stop of PDCCH monitoring according to search space sets with group index 1, if any,
a ‘01’ value for the bits indicates start of PDCCH monitoring according to search space sets with group index 1 and stop of PDCCH monitoring according to search space sets with group index 0, if any, and the UE sets the timer value to the one provided by searchSpaceSwitchTimer-r17, if provided,
a ‘10’ value for the bits indicates skipping PDCCH monitoring for a duration provided by the first value in the set of durations,
a ‘11’ value for the bits indicates skipping PDCCH monitoring for a duration provided by the second value in the set of durations.

When the PDCCH monitoring adaptation field indicates to a UE to start PDCCH monitoring according to search space sets with a first group index and stop PDCCH monitoring according to search space sets with a second group index, the UE applies the indication
at the beginning of a first slot that is at least P_{switch} symbols after the last symbol of the PDCCH reception providing the DCI format with the PDCCH monitoring adaptation field when μ∈{0, 1, 2, 3},
at the beginning of a first slot, of a slot group of Xₛ slots, that is at least P_{switch} symbols after the last symbol of the PDCCH reception providing the DCI format with the PDCCH monitoring adaptation field when μ∈{5, 6}.

When the PDCCH monitoring adaptation field indicates to a UE to skip PDCCH monitoring for a duration on the active DL BWP of a serving cell, the UE starts skipping of PDCCH monitoring at the beginning of a first slot that is after the last symbol of the PDCCH reception providing the DCI format with the PDCCH monitoring adaptation field.
If the UE transmits a PUCCH providing a positive SR before the UE detects a DCI format providing the PDCCH monitoring adaptation field indicating to the UE to skip PDCCH monitoring for the duration on the active DL BWP of the serving cell, the UE monitors PDCCH regardless of PDCCH skipping indication on all serving cells of the corresponding Cell Group when the SR is pending [11, TS 38.321].

If the UE transmits a PUCCH providing a positive SR after the UE detects a DCI format providing the PDCCH monitoring adaptation field indicating to the UE to skip PDCCH monitoring for the duration on the active DL BWP of the serving cell, the UE resumes PDCCH monitoring starting at the beginning of a first slot that is after a last symbol of the PUCCH transmission in all serving cells of the corresponding Cell Group.

When the UE is provided pdcchMornitoringResumptionAfterNack, after the UE detects a DCI format providing the PDCCH monitoring adaptation field indicating to the UE to skip PDCCH monitoring for the duration on the active DL BWP of the serving cell, if the UE transmits a PUCCH or a PUSCH providing a NACK value associated with a PDSCH reception that is scheduled by a DCI format in a PDCCH reception on the serving cell, the UE terminates PDCCH skipping, starting from the beginning of a first slot that is after a last symbol of the PUCCH or PUSCH transmission on the serving cell.

During the time of ra-Response Window or msgB-Response Window or the duration where ra-ContentionResolutionTimer is running, the UE shall not skip PDCCH monitoring on SpCell.

After the UE detects a DCI format providing the PDCCH monitoring adaptation field indicating to the UE to skip PDCCH monitoring for the duration on the active DL BWP of a SpCell, when contention resolution is successful [11, TS 38.321], the UE resumes PDCCH monitoring on the SpCell.

After the UE detects a DCI format providing the PDCCH monitoring adaptation field indicating to the UE to skip PDCCH monitoring for the duration on the active DL BWP of a serving cell, when a pending SR is cancelled [11, TS 38.321], the UE resumes PDCCH monitoring in all serving cells of the corresponding Cell Group.

If the UE transmits a RACH due to positive SR, the UE shall not skip PDCCH monitoring on any serving cell of the corresponding Cell Group during the time of ra-ResponseWindow or msgB-ResponseWindow or the duration where ra-ContentionResolutionTimer is running. If DRX is configured and the DRX group of the serving cell enters outside Active Time, the UE terminates PDCCH skipping for the serving cell.

If the UE changes to a new active DL BWP of the serving cell by the expiration of bwp-Inactivity Timer or by RRC configuration, the UE
resumes PDCCH monitoring according to the search space sets on the new active BWP of the serving cell when UE is in a PDCCH skipping duration, if the UE is not provided searchSpaceGroupIdList-r17 on the new active DL BWP,
monitors PDCCH according to search space sets with group index 0 on the new active BWP of the serving cell, if the UE is provided searchSpaceGroupIdList-r17.

If a UE is provided group indexes for a Type3-PDCCH CSS set or a USS set by searchSpaceGroupIdList-r17 and a timer value by searchSpaceSwitchTimer-r17 for PDCCH monitoring an active DL BWP of on a serving cell and the timer is running, the UE
resets the timer after a slot of the active DL BWP of the serving cell if the UE detects a DCI format in a PDCCH reception in the slot for with CRC scrambled by C-RNTI/CS-RNTI/MCS-C-RNTI/G-RNTI for multicast/G-CS-RNTI,
otherwise, decrements the timer value by one after a slot of the active DL BWP of the serving cell.

When the timer expires in a first slot, the UE monitors PDCCH on the serving cell according to search space sets with group index 0 starting in a second slot that
is not earlier than P_{switch} symbols after the first slot when μ∈{0, 1, 2, 3},
is a first slot in a slot group of Xₛ slots that is not earlier than P_{switch} symbols after the first slot when μ∈{5, 6},
is not earlier than a slot where a PDCCH skipping duration expires, if applicable.

When a UE receives
a first PDCCH in a first slot that provides a DCI format with a PDCCH monitoring adaptation field having a first value indicating skipping PDCCH monitoring, or indicating start of PDCCH monitoring according to a search space sets with a first group index and stop of PDCCH monitoring according to search space sets with a second group index, for an active DL BWP, and
a second PDCCH that provides a DCI format with a PDCCH monitoring adaptation field having a second value indicating skipping PDCCH monitoring, or indicating start of PDCCH monitoring according to search space sets with a first group index and stop of PDCCH monitoring according to search space sets with a second group index different than the first group index, for the active DL BWP where the second PDCCH is received,
   in the first slot if the first value indicates skipping PDCCH monitoring,
   before a slot that is at least P_{switch} symbols after the first slot if the first value indicates start of PDCCH monitoring according to search space sets with a first group index, the UE does not expect the second value to be different than the first value.

A UE does not expect to receive in a second slot a PDCCH on an active DL BWP that provides a DCI format indicating skipping PDCCH monitoring or start of PDCCH monitoring according to search space sets with group index 1 or 2 for the active DL BWP, if the second slot is not at least P_{switch} symbols after a first slot where the timer expires.

The following describes the UE procedures for adaptation of cell operation.

A UE configured for operation on a serving cell according to one or both of a cell DTX operation and a cell DRX operation by cellDTXDRX-Config for the serving cell [11, TS 38.321], can be additionally provided by dci-Format2-9 a Type3-PDCCH CSS set to monitor PDCCH for detection of DCI format 2_9 as described in clause 10.1 during Active Time [11, TS 38.321], and a location in DCI format 2_9 by positionInDCI-cellDTRX of a cell DTX/DRX indication field for the serving cell and/or a NES-mode indication field for the PCell
if the UE is configured with both cell DTX operation and cell DRX operation for the serving cell and if cellDTXDRX-Llactivation is provided, the cell DTX/DRX indication field includes two bits where the first bit indicates the cell DTX operation and the second bit indicates the cell DRX operation,
if the UE is configured with only one of the cell DTX operation and cell DRX operation for the serving cell and if cellDTXDRX-Llactivation is provided, the cell DTX/DRX indication field includes one bit indicating one of the cell DTX operation and cell DRX operation, respectively, for the serving cell,
a ‘0’ value for a bit of the cell DTX/DRX indication field indicates deactivation of cell DTX or of cell DRX,
a ‘1’ value for a bit of the cell DTX/DRX indication field indicates activation of cell DTX or of cell DRX
if the serving cell is configured with a SUL carrier, the cell DTX/DRX indication field indication for activation or deactivation of cell DRX applies to both the UL carrier and the SUL carrier,
if nesEvent is configured, the NES-mode indication field includes one bit indicating NES-specific CHO execution condition, as described in [12, TS 38.331],
a ‘0’ value for the NES-mode indication field indicates NES-specific CHO execution condition is disabled,
a ‘1’ value for the NES-mode indication field, indicates NES-specific CHO execution condition is enabled.

A UE does not expect to monitor PDCCH for detection of DCI format 2_9 on more than one serving cells of one cell group.

When a UE receives in slot m on the active DL BWP of a first serving cell a PDCCH providing DCI format 2_9 that indicates a change in activation or deactivation of a current cell DTX operation or cell DRX operation for a second serving cell, the UE operates on the second serving cell according to the indicated cell DTX operation or cell DRX operation starting from a slot on the active DL BWP or on the active UL BWP of the second serving cell, respectively, that is not before the beginning of the slot m+d on the active DL BWP of the first serving cell where d is a number of slots for the SCS of the active DL BWP of the first serving cell in Table 1-5.

TABLE 1-5
Minimum time gap value d

| SCS | Number |
|---|---|
| (kHz) | of slots |
| 15 | 3 |
| 30 | 6 |
| 60 | 12 |
| 120 | 24 |
| 480 | 96 |
| 960 | 192 |

Various embodiments of the present disclosure recognize that there is a need to facilitate reduced UE power consumption for DL control channel by reducing the number of blind decoding for PDCCH reception.

Accordingly, various embodiments of the present disclosure may provide methods and apparatuses to support reduced PDCCH blind decoding based on gNB assistance information. Various embodiments may apply to any deployments, verticals, or scenarios including in FR1, FR2, FR3, FR4,with eMBB, URLLC and IIOT, mMTC and IoT including LTE NB-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multi-cast broadcast services (MBS), with integrated sensing and communication (ISAC) operation, and so on. Further, in various embodiments and examples throughout the present disclosure, a 6G/5G gNB or a 4G eNB can refer to a central unit (CU) or a distributed unit (DU) or a remote unit (RU) or a transmission-reception point (TRP) or other architectural units or functional/logical entities for a corresponding base station, or a variation or collection or combination thereof.

### Contents of Assistance Information For Reduced Blind Decoding

In some embodiments, the UE can be provided assistance-information for reduced blind decoding for the DL control channel, such as information of CCE indexes or PDCCH candidate index corresponding to subsequent PDCCH receptions. The UE can monitor or receive the subsequent PDCCHs based on the assistance information, such as in the indicated CCE indexes or PDCCH candidate indexes. The subsequent PDCCH receptions can correspond to same or different slots or PDCCH monitoring occasions (MOs), same or different CORESETs or search space sets, same or different TRPs/DUs/CORESET groups/CORESET pool indexes, same or different beams or TCI states, same or different serving (or possibly non-serving) cells, same or different link direction (DL or UL or SL), and so on. Such information can be predetermined in the specifications of system operation or can be explicitly or implicitly provided by the assistance information.

This can be beneficial, for example, when the UE may receive continuous (or almost continuous or frequent) DL/UL scheduling e.g. in a number of slots or across a number of cells, and the gNB may decide on, and can inform the UE of, the corresponding CCEs to be used for subsequent DCI formats. The UE can achieve power saving and complexity reduction by using such assistance information.

BD/CCE information: Assistance information can include an indication of CCEs or a PDCCH candidate corresponding to a subsequent PDCCH. For example, assistance information can indicate a starting CCE index or an index of a PDCCH candidate associated with the subsequent PDCCH.

For example, assistance information can indicate a value n_{CCE,0} of a starting CCE index from {0, 1, . . . , N_{CCE,p}−1}. For example, the value is provided by a field with size ┌log₂ N_{CCE,p}┐ bits, where ┌⋅┐ is the ceiling operation, such as X bits based on CCE size definition in [REF1, TS 38.211]. For example, X can be in a range from 3 bits to 7 bits.

The indication applies at least when the UE is aware of a CORESET index p associated with the subsequent PDCCH. For example, the specifications of system operation can predetermine that the subsequent PDCCH is associated with a same CORESET index p as a first PDCCH reception that:
provides the first DCI format that includes the assistance information, or
schedules a first PDSCH that provides the assistance information, therefore, a same N_{CCE,p} value is applicable. The method can also apply when the UE can otherwise identify a CORESET index p for the subsequent PDCCH reception, as subsequently described under “CORESET information”.

For example, when the UE is aware of an aggregation level (AL) value L for the subsequent PDCCH, the UE can determine the set of CCE indexes for the subsequent PDCCH reception that as {n_{CCE,0}, n_{CCE,0}+1, . . . , n_{CCE,0}+L−1}. For example, the specifications of system operation can predetermine that the subsequent PDCCH is associated with a same AL value L as that for a first PDCCH reception:
that provides the first DCI format that includes the assistance information, or
that schedules a first PDSCH that provides the assistance information.

For example, the UE can otherwise identify an AL value L for the subsequent PDCCH reception, as subsequently described under “Aggregation level information”.

Such method can be also beneficial, for example, regardless of whether the subsequent/second PDCCH reception is in a same search space set as or in a different search space than that for the first PDCCH candidate (at least so long as both the first and the second PDCCH candidates are associated with the same CORESET).

In another example, assistance information can indicate a value of a PDCCH candidate index

$${m}_{s , {n}_{CI}}^{( L )}$$

from

$$\{ 0 , … , {M}_{s , {n}_{CI}}^{( L )} - 1 \}$$

associated with a subsequent PDCCH. For example,

$${M}_{s , {n}_{CI}}^{( L )}$$

is the number of PDCCH candidates that the UE is configured to monitor for aggregation level L of a search space set s for a serving cell corresponding to n_{CI}. For example, the UE applies the value

$${m}_{s , {n}_{CI}}^{( L )}$$

in the following search space equation to determine the CCE indexes for the subsequent PDCCH reception, as previously described.

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

For example, the value is provided by a field with size

$$⌈ {log}_{2} {M}_{s , {n}_{CI}}^{( L )} ⌉ bits ,$$

such as Y≤6 bits.

The method applies at least when the UE is aware of one or more of: a search space index s, an aggregation level (AL) value L, or a scheduled cell corresponding to n_{CI}, associated with the subsequent PDCCH. For example, the specifications of system operation can predetermine that the subsequent PDCCH is associated with a same search space set (that is, a same search space set index s), or a same aggregation level (AL) value L, or a same scheduled cell corresponding to a same n_{CI}, as that/those for a first PDCCH reception:
that provides the first DCI format that includes the assistance information, or
that schedules a first PDSCH that provides the assistance information.

The method can also apply when the UE can otherwise identify a search space index s, or an AL value L, or a scheduled cell with an n_{CI} value, for the subsequent PDCCH reception, as subsequently described under “Search space set information”, “Aggregation level information”, and “Scheduled cell information”.

In another example, assistance information can indicate a subset of CCE indexes or a subset of PDCCH candidate indexes for the subsequent PDCCH reception. For example, the UE performs limited blind decoding operation only within the indicated subset, instead of full blind decoding across different configured CCE indexes and PDCCH candidates.

For example, assistance information indicates a subset of n_{CCE,0} values as potential starting CCE indexes, or a subset of

$${m}_{s , {n}_{CI}}^{( L )}$$

values as potential PDCCH candidate indexes. For example, the subset/group can include G=2 or 4 values, resulting in corresponding fields with (X-1) or (X-2) bits or in general size ┌log₂(N_{CCE,p}/G)┐ bits for n_{CCE,0}, or (Y-1) or (Y-2) bits or in general

$$⌈ {log}_{2} ( {M}_{s , {n}_{CI}}^{( L )} / G ) ⌉ bits$$

for

$${m}_{s , {n}_{CI}}^{( L )}$$

(or a summation thereof across different values s of search space index). For example, the UE performs limited blind decoding operation within a group of PDCCH candidates associated with an indicated subset of n_{CCE,0} or

$${m}_{s , {n}_{CI}}^{( L )}$$

values, instead of a full blind decoding operation across different PDCCH candidates and CCEs.

For example, a value G of the subset/group of CCEs or PDCCH candidates is configured by higher layers. For example, the configuration of G can be separate for different CORESETs, different search space sets, different AL values, or different scheduled cells. In another example, the configuration of G can be same/common for one or more of the aforementioned cases.

For example, grouping of PDCCH candidates or CCEs can be predetermined in the specifications or can be based on higher layer configuration. In one example, the set {0, 1, . . . , N_{CCE,p}−1} are grouped into subsets of size G in ascending or descending order of indexes. For example, when G=2, a first subset includes n_{CCE,0} starting CCE indexes {0, 1}, a second subset includes indexes {2, 3}, a third subset includes indexes {4, 5}, and so on. Similar for grouping of PDCCH candidate indexes

$$\{ 0 , … , {M}_{s , {n}_{CI}}^{( L )} - 1 \} .$$

In another example, the UE can determine the grouping of PDCCH candidates or CCEs based on the PDCCH search space formula. For example, the search space formula can be modified to include a parameter g, from a set {0, 1, . . . , G−1}.

In one realization, for each PDCCH candidate index, the UE can run the equation through values g=0, 1, . . . , G−1, and determine a subset/group of PDCCH candidates with a number G of different starting CCE indexes or alternatively G different CCEs corresponding to different values of parameter g. For example, the UE does not expect a PDCCH candidate to be included in more than one subset/group of PDCCH candidates. Similar applies to groups of CCEs.

In another realization, the parameter g, from a set {0, 1, . . . , G−1} can refer to an index of a subset/group of PDCCH candidates. For example, each group of PDCCH candidates can include same number of PDCCH candidates, therefore the UE determine a size of a subset/group of CCEs to be ┌log₂(N_{CCE,p}/G)┐, or a size of a subset/group of PDCCH candidates to be

$$⌈ {log}_{2} ( {M}_{s , {n}_{CI}}^{( L )} / G ) ⌉ ,$$

or a summation thereof across different values s of search space index. In another example, a size of a subset/group of CCEs or PDCCH candidates can be configured by higher layers, and can be same or different for different subsets/groups. For example, once the UE determines an index g of an applicable group of PDCCH candidates or CCEs, the UE can determine a corresponding number e.g. ┌log₂(N_{CCE,p}/G)┐ starting CCEs or a corresponding number ┌log₂(M_{s,n}_{_{CI}}^{(L)}/G)┐ of PDCCH candidates associated with the group index g.

For any realization, such as the first realization or the second realization, for example, the search space equation can be modified as:

$${Y}_{p , {n}_{s , f}^{μ} , g} = ( g \cdot {A}_{p} \cdot {y}_{p , {n}_{s , f}^{μ} - 1} ) mod D$$

$$or$$

$${Y}_{p , {n}_{s , f}^{μ} , g} = ( g + {A}_{p} \cdot {y}_{p , {n}_{s , f}^{μ} - 1} ) mod D$$

or the search space parameter can be modified as:

$$L \cdot \{ ( {Y}_{p , {n}_{s , f}^{μ} , g} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

$$or$$

$$L \cdot \{ ( {Y}_{p , {n}_{s , f}^{μ}} + ⌊ \frac{g \cdot {m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

$$or$$

$$L \cdot \{ ( {Y}_{p , {n}_{s , f}^{μ}} + ⌊ \frac{g \cdot {m}_{s , {n}_{CI}}^{( L )} \cdot {N}_{CCE , p}}{G \cdot L \cdot {M}_{s , max}^{( L )}} ⌋ + {n}_{CI} ) mod ⌊ {N}_{CCE , p} / L ⌋ \} + i$$

$$or$$

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} + g ) mod ⌊ {N}_{CCE , p} / L ⌋ \} + i$$

$$or$$

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i \cdot g$$

$$or$$

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i + g$$

or variations or combinations thereof.

In another example, there can be a predetermined or higher layer configured association among groups/subsets of CCEs or PDCCH candidates with UE groups (similar to paging early indication (PEI) or low-power wake-up signal (LP-WUS)). For example, the UE can be predetermined a rule or configured by higher layers a mapping among slots or frames in which the UE receives a PDCCH/PDSCH providing assistance-information and UE IDs or UE group IDs. For example, when the UE monitors a CSS set to receive the assistance information in a GC-DCI format, the UE can be configured first monitoring occasions (MOs) associated with first UE IDs or first UE group IDs, and second MOs associated with second UE IDs or second UE groups IDs, and so on. For example, a UE with a first UE ID or associated with a first UE group ID monitors the assistance information only in the first MOs, and may not monitor the GC-DCI format in the second MOs.

In another example, the subsets for n_{CCE,0} values or

$${m}_{s , {n}_{CI}}^{( L )}$$

values corresponding to different groups of starting CCEs or PDCCH candidates can be explicitly provided by higher layer configuration. For example, no predetermined grouping or predefined rule may be applied to determine the corresponding subsets. For example, different groups/subsets can have same or different sizes. For example, the configuration of aforementioned subsets/groups can be separate for different CORESETs, different search space sets, different AL values, or different scheduled cells. In another example, the configuration of subsets/groups can be same/common for one or more of the aforementioned cases.

In another example, assistance information can include information of multiple n_{CCE,0} values or multiple

$${m}_{s , {n}_{CI}}^{( L )}$$

values for a subsequent PDCCH reception, such as by using explicit indexes, or by a bitmap, separate from or in combination with groups/subsets as previously described.

CORESET information: In one example, assistance information can include information of a CORESET index p for a subsequent PDCCH reception, such as by a 2-bit or 3-bit field. For example, there is a predetermined (or configured) mapping among values of the field and CORESET index p values. For example, field value ‘000’ maps to p=0, field value ‘001’ maps to p=0, and so on.

For example, a value of the field can exclude a CORESET index p value corresponding to a CORESET associated with the first PDCCH reception.

Such information can be beneficial, for example, when the subsequent PDCCH can be associated with a second/different CORESET than that for a first PDCCH
that provides the first DCI format that includes the assistance information, or
that schedules a first PDSCH that provides the assistance information.
   For example, a flag in the assistance information can indicate whether same or different CORESET applies.

In another example, a CORESET index p is not included in the assistance information. For example, instead of a full blind decoding across different CCEs in different CORESETs, the UE performs a limited blind decoding operation with starting CCE n_{CCE,0,p} across all/different values of a CORESET index p, or across values of CORESET index p for which the UE monitors PDCCH in associated search space sets in the corresponding MO for the subsequent PDCCH reception.

In another example, assistance information can provide information of a group of CORESETs, such as 1 bit to indicate 2 values, wherein each value refers to one of two configured groups of CORESETs, such as two different CORESETpoolIndex values associated with two TRPs.

Search space set information: In one example, assistance information can include information of an applicable search space set index s corresponding to the subsequent PDCCH reception, e.g., by including a field with S≤6 bits. For example, there can be a predetermined or higher layer configured mapping among the field values and search space set index s values.

For example, the mapping may not include field values for certain search space set index s values.

For example, search space set index values s can be excluded when the UE is aware of or is provided information of a CORESET index p associated with the subsequent PDCCH reception, and a search space set with index s is not associated with the CORESET index p.

For example, search space set index values s can be excluded when the UE is not configured corresponding search space sets in a PDCCH MO associated with the subsequent PDCCH reception.

For example, a value s can be excluded when s is a search space set index associated with a first PDCCH:
that provides the first DCI format that includes the assistance information, or
that schedules a first PDSCH that provides the assistance information.
   For example, a flag in the assistance information can indicate whether same or different search space index applies.

Such methods can be beneficial, for example, at least when a PDCCH candidate for the subsequent PDCCH reception is not in a same search space set as the first PDCCH reception.

In another example, the information of a corresponding search space index s is not provided to the UE. For example, instead of monitoring different PDCCH candidates corresponding to different CCEs and different search space sets, the UE performs limited blind decoding over a reduced set of PDCCH candidate indexes

$${m}_{s , {n}_{CI}}^{( L )}$$

across all/different search space set indexes s, or across search space set indexes s that are not excluded per one or more of the aforementioned examples.

In another example, assistance information can include information of an index of a group of search space sets, such as one of two or three search space set groups (SSSGs), using 1 or 2 bits. For example, the UE identifies a starting CCE or a PDCCH candidate only within search space sets that are included in the indicated SSSG.

Aggregation level information: In one example, assistance information can include information of an applicable aggregation level (AL) L for the subsequent PDCCH reception. For example, the assistance information can include an AL field with values mapped to different AL values. For example, field value ‘000’ maps to L=1, value ‘001’ maps to L=2, value ‘010’ maps to L=4, and so on.

Such method can be beneficial, for example, when a AL value L for the subsequent PDCCH reception can be separate/different from an AL value associated with a first PDCCH:
that provides the first DCI format that includes the assistance information, or
that schedules a first PDSCH that provides the assistance information.
   For example, the channel condition has changed, such as when the subsequent PDCCH corresponds to a future slot, or when an increased (or decreased) reliability is needed for the subsequent PDCCH.

In one example, the mapping can exclude certain AL values, such as a value of the AL for the first PDCCH. For example, when the AL for the first DCI format is L=2, field value ‘000’ maps to L=1, value ‘001’ maps to L=4 (that is, L=2 is skipped), value ‘010’ maps to L=8, and so on.

In another example, the UE may have no/limited knowledge about an AL value corresponding to the subsequent PDCCH reception. For example, the UE performs blind decoding to determine a value of the aggregation level L for the subsequent PDCCH. For example, instead of a full blind decoding for PDCCH candidates with different CCEs and different AL values, the UE performs a limited blind decoding by attempting to decode only PDCCH candidates with CCEs starting from CCE index nCCE,0 and with different AL values, for example, {n_{CCE,0}, n_{CCE,0}+1, . . . , N_{CCE,0}+L}, for different values of L, such as L=1, 2, 4, 8, 16. For example, the UE performs limited, blind decoding only within PDCCH candidate indexes

$${m}_{s , {n}_{CI}}^{( L )} ,$$

for different values of L, such as L=1, 2, 4, 8, 16. For example, the UE performs blind decoding only with respect to AL values that are associated with the configured search space sets for a next slot/MO or for an indicated slot/MO.

For example, a flag in the assistance information can indicate whether the AL value for the subsequent PDCCH is same as (e.g., flag value ‘1’) or different than (e.g., flag value ‘0’) that for the first PDCCH reception. For example, the UE only performs the limited blind decoding as previously described (and value L for an AL of the first DCI format can be excluded) when the flag has value ‘0’, and performs no blind decoding (at least with respect to AL value) by assuming a same AL level as the first DCI format when the flag has value ‘1’.

For example, a higher layer parameter can indicate whether such flag is present in the assistance information. When the flag is not present, the UE behavior is predetermined in the specifications of system operations, for example, checking different possible L values, or default assumption of reusing an AL value of the first PDCCH reception.

For example, AL field in the assistance information is present only when the flag for same/different AL indicates value ‘0’, that is, different AL value from the first PDCCH reception.

Scheduled cell (n_CI) information: In one example, the specifications of system operation can predetermine as default assumption that assistance information corresponds to a same scheduled cell (or a same set of co-scheduled cells) as one on/for which the UE receives a first PDCCH that provides or schedules the assistance information. In another example, assistance information can be for a subsequent PDCCH that corresponds to a different scheduled cell.

For example, assistance information can include a flag to indicate whether the scheduled cell (or a set of co-scheduled cells) n_CI is same as or different from that for the first PDCCH reception.

For example, assistance information can include an n_CI index from the search space equation associated with the subsequent PDCCH, using a field with C≤3 bits.

In another example, the UE may perform a limited blind decoding only within CCEs or PDCCH candidates associated with starting CCE index n_{CCE.0} or PDCCH candidate indexe

$${m}_{s , {n}_{CI}}^{( L )} ,$$

across different n_CI values.

Various examples and embodiments throughout the present disclosure can also apply when “scheduled cell” is replaced with “set of co-scheduled cells” or variations thereof to imply multi-cell scheduling.

In one example, various fields or flags corresponding to one or more of CORESET information, Search space set information, aggregation level information, and scheduled cell information can be jointly provided by a same field or a same parameter. For example, a first entry/value of such joint parameter indicate two or more of a first CORESET index, a first Search space set index, a first AL value, and a first scheduled cell, and a second entry/value of such joint parameter indicate two or more of a second CORESET index, a second Search space set index, a second AL value, and a second scheduled cell, and so on. For example, fewer bits may be used when using such joint parameter compared to multiple individual fields or flags.

Monitoring occasion (MO)/Slot information: In one example, the specifications of system operation can predetermine as a default assumption that assistance information can correspond to (a same slot or) an immediately next slot after a slot in which the UE receives the assistance information. In another example, a processing time or an application time can be predetermined in the specifications of system operation or can be higher layer configured or reported by the UE for applying the assistance information, in which case the assistance information can correspond to a first slot after the processing/application time. In another example, assistance information can include information of a PDCCH monitoring occasion (MO) or a slot index for which the assistance information applies based on a reference time.

For example, time resources, such as MOs or slots, are counted with respect to (an SCS of the active BWP of):
a scheduled cell for which the subsequent PDCCH is to be monitored/received (e.g., corresponding to the applicable n_CI value), or
a scheduled cell for which a first PDCCH is received that provides a first DCI format, and the first DCI format includes the assistance information (and possibly also schedules a PDSCH/PUSCH on the scheduled cell), or
a scheduled cell on which a first PDSCH was received, and the first PDSCH provided the assistance information, or
a corresponding scheduling cell.

In another example, an SCS for counting the MOs/slots is configured by higher layers, or provided by assistance information. For example, such configuration or indication can be explicit. For example, higher layer information or the assistance information can indicate the slots are counted with respect to which of the aforementioned examples of SCS for scheduled/scheduling cells.

In one example, the UE provides HARQ-ACK information in response to an L1/L2 signaling that provides the assistance information. For example, the UE applies the assistance information in a number of slots, for example equivalent to 3 msec or another predetermined/configured value possibly based on UE capability, after the UE transmits/would transmit a PUCCH or PUSCH that provides HARQ-ACK information corresponding to the assistance information.

For example, assistance information can include explicit or implicit information to indicate a slot or MO for the subsequent PDCCH reception.

In one example, assistance information can indicate a slot offset for a subsequent PDCCH reception with respect to a slot in which the UE receives a PDCCH that provides the assistance information, wherein counting of slots for the slot offset includes only slots that the UE is configured to monitor/receive PDCCH in.

For example, the UE does not count a slot towards such slot offset when the UE is not configured to monitor PDCCH in the slot. For example, such exclusion of slots in the slot counting can be based on PDCCH monitoring configuration across different configured/activated CORESETs or different configured/activated search space sets. In another variation, such exclusion of slots in the slot counting can be based on PDCCH monitoring configuration only in a same CORESET in which the UE receives the PDCCH providing the assistance information, or only in a CORESET indicated or implied by the assistance information for reception of the subsequent PDCCH.

In another example, such exclusion of slots in the slot counting can be based on PDCCH monitoring configuration only for a same search space in which the UE receives the PDCCH providing the assistance information, or only in a search space set indicated or implied by the assistance information for reception of the subsequent PDCCH.

For example, assistance information can include a slot offset value for a number of slots, such as N slots, (or other time resource unit such as sub-slots, spans, or symbols, or frames) for the subsequent PDCCH reception. The value of N slots can be counted with respect to the SCS (of the active BWP) of the scheduled/scheduling cell, as previously described.

For example, the slot offset value can be with respect to a reference time. For example, the reference time can be:
a slot in which the UE receives the assistance information, or
K slots after a slot in which the UE receives the assistance information, wherein K slots is based on the application or processing time, such as based on UE capability or higher layer configuration or based on HARQ-ACK processing time, as previously described, or
a first slot after the processing time as described above, or
a start of a frame in which the UE receives the assistance information or a start of a next frame after a frame in which the UE receives the assistance information, or
a start of a reference frame, such as frame #0, or a reference frame number (such as SFN value) indicated by the assistance information.

The reference slot can be counted with respect to the SCS (of the active BWP) of the scheduled/scheduling cell, as previously described. For example, the reference slot and the slot offset can be counted with respect to a same SCS or with respect to different SCS configurations, as previously described.

In one example, assistance information can indicate a relative index of an MO, or a relative number of MOs, such as N MOs, for a subsequent PDCCH reception with respect to an MO in which the UE receives a PDCCH that provides the assistance information, wherein counting of MO indexes can include MOs associated with:
different configured/activated CORESETs, or
different configured/activated search space sets, or
only in a same CORESET in which the UE receives the PDCCH providing the assistance information, or
only in a CORESET (or a group of CORESETs) indicated or implied by the assistance information for reception of the subsequent PDCCH, or
only for a same search space in which the UE receives the PDCCH providing the assistance information, or
only in a search space set (or an SSSG) indicated or implied by the assistance information for reception of the subsequent PDCCH.

For example, when the UE is configured multiple MOs in a same slot, assistance information can include information of an MO for the subsequent PDCCH reception.

For example, a value range for N can be predetermined such as N={1, 2} using 1 bit or N={1, 2, 3, 4} using 2 bits. For example, a maximum value N_max can be configured, and a number of values, such as 2 or 4 values for N based on N_max can be determined based on a predefined rule, such as N={N_max/2, N_max} using 1 bit or N = {N_max/8, N_max |4, N_max/2, N_max} using 2 bits. In another example, a list of 2 or 4 offset values can be provided by higher layer information, such as N={N1, N2} using 1 bit or N={N1, N2, N3, N4}, wherein the values N1, N2, N3, N4 are provided by RRC configuration. For example, value ‘00’ in the assistance information corresponds to N1, value ‘01’ corresponds to N2, and so on.

Various examples concerning timeline for application of assistance information or associated acknowledgment can apply regardless of whether the assistance information is provided for one subsequent PDCCH reception corresponding to one slot/MO or for multiple subsequent PDCCH receptions corresponding to multiple slots/MOs.

DL/UL information: In one example, assistance information can include information whether the subsequent PDCCH reception is for a DL DCI format or an UL DCI format. Such information can be beneficial/provided, for example, when the UE is configured to monitor PDCCHs for both DL DCI formats and UL DCI formats in the next slot or a certain subsequent slot. In another example, the UE can perform blind decoding with respect to one or both DL DCI format(s) and UL DCI format(s), based on search space configuration applicable to the corresponding slot or the corresponding PDCCH monitoring occasion (MO). In another example, the UE may assume that a link direction for a DCI format (such as DL DCI format or UL DCI format) in a subsequent PDCCH reception can be same as that for a DCI format that provides the assistance information or that for a DCI format that schedules a first PDSCH that provides the assistance information.

Beam/TRP information: In one example, assistance information can provide beam information, such as TCI state, or TRP/DU information, such as CORESETpool index or CORESET group index. In another example, assistance information can indicate an index of a TCI state or a group of TCI states, and the UE determines PDCCH candidates in CORESETs that are associated with the indicated TCI state or group of TCI states.

In another example, the UE can be already provided an indicated TCI state that applies to various signals or channels in a number of slots (or otherwise a time duration) that includes a corresponding slot or MO for a subsequent PDCCH reception. For example, the UE determines a PDCCH candidate within CORESETs that are associated with the indicated TCI state.

Multiple PDCCHs: In one example, assistance information can include BD/CCE information or other information (such as information for CORESET, search space set, AL value, scheduled cell, MO/slot offset, or DL/UL) for more than one subsequent PDCCH receptions.

For example, the UE can receive assistance information for multiple PDCCH receptions corresponding to multiple DCI formats for different scheduled cells in a next slot/MO (or in certain same or different subsequent slots).

For example, the UE can receive assistance information for one or multiple PDCCH receptions corresponding to one or more DL DCI formats and additional one or multiple PDCCH receptions corresponding to one or more UL DCI formats for a same (or different) scheduled cell in the next slot (or in certain same or different subsequent slots).

For example, assistance information can be predetermined in the specifications of system operation or can be higher layer configured to provide information for a certain number of subsequent PDCCH receptions, such as 4 PDCCHs.

For example, some information may be jointly or commonly provided for the multiple PDCDCH receptions, such as CORESET index or AL value, and some other information may be provided separately for each of the multiple PDCCH receptions, such as the BD/CCE index information or search space set index information or MO/slot offset information.

For example, size of information fields for different subsequent PDCCH receptions can be predetermined (for example, same number of bits) or can be different (for example, indicated in the assistance information or provided by higher layers).

For example, assistance information can include a bitmap with a certain number of bits for each subsequent PDCCH reception.

For example, there can be predetermined (or higher layer configured) rule or relationship among assistance information for multiple PDCCHs. For example, a starting CCE indicated by the assistance information applies to a reference/first PDCCH among the multiple PDCCHs, and the UE can determine CCEs for the remaining PDCCHs based on the starting CCE and the corresponding AL value.

For example, when same AL value L applies to all of the multiple PDCCHs, the UE determines CCEs for a first PDCCH to be {n_{CCE,0}, N_{CCE,0}+1, . . . , N_{CCE,0}+L−1}, and CCEs for a second PDCCH to be {n_{CCE,0}+L, n_{CCE,0}+L+1, . . . , n_{CCE,0}+2L}, and so on. In general, the UE determines CCEs for a k-th PDCCH to be {n_{CCE,0}+(k−1)L, n_{CCE,0}+(k−1)L+1, . . . , n_{CCE,0}+kL}. For example, different PDCCHs can have different AL values, and the UE determines CCEs for a k-th PDCCH to be

$$\{ {n}_{CCE , 0} + {\sum }_{i = 0}^{k - 1} {L}_{i} , {n}_{CCE , 0} + {\sum }_{i = 0}^{k - 1} {L}_{i} + 1 , … , {n}_{CCE , 0} + {\sum }_{i = 0}^{k} {L}_{i} \} .$$

Such CCEs can be physical or logical CCEs before or after any scrambling or permutation. Such method applies at least when the PDCCH candidates correspond to, for example, different scheduled cells of the same UE or different slots of a same UE such as for a number of k consecutive slots.

For example, when same PDCCH candidate indexes for the multiple PDCCHs are consecutive, a PDCCH candidate index indicated by the assistance information applies to a reference/first PDCCH, and the UE can determine PDCCH candidate indexes in ascending order of the indexes. For example, when the assistance information indicates a reference/first PDCCH in a PDCCH candidate index

$${m}_{s , n , CI}^{( L )} ,$$

the UE determines that the second PDCCH is in a PDCCH candidate

$${m}_{s , {n}_{CI}}^{( L )} + 1 ,$$

a third PDCCH is in a PDCCH candidate index

$${m}_{s , {n}_{CI}}^{( L )} + 2 ,$$

and so on. In general, a k-th PDCCH can be in a PDCCH candidate index

$${m}_{s , {n}_{CI}}^{( L )} + k - 1 .$$

Such method applies at least when the multiple PDCCHs correspond to a same scheduled cell (or a same set of co-scheduled cells) for a same UE, in different slots, such as for a number of k consecutive slots.

In another example, the UE can determine that the second PDCCH is in a PDCCH candidate

$${m}_{s , {n}_{CI} + 1}^{( L )} ,$$

a third PDCCH is in a PDCCH candidate index

$${m}_{s , {n}_{CI} + 2}^{( L )} ,$$

and so on. In general, a k-th PDCCH can be in a PDCCH candidate index

$${m}_{s , {n}_{CI} + k - 1}^{( L )} .$$

Such method can apply, for example, when the multiple PDCCHs correspond to different scheduled cells (or different sets of co-scheduled cells) for a same UE. For example, different PDCCHs can correspond to different scheduled cell indexes, and the UE determines a k-th PDCCH to be in a PDCCH candidate index

$${m}_{s , {n}_{{CI}_{k}}}^{( L )} .$$

Similar method applies when the multiple PDCCHs indicated by the assistance information correspond to different (consecutive or non-consecutive) search space set indexes.

In another realization, similar methods can apply when different PDCCH candidates correspond to different UEs. For example, a k-th UE uses a k-th PDCCH corresponding to CCEs {n_{CCE,0}+(k−1)L, n_{CCE,0}+(k−1)L+1, . . . , n_{CCE,0}+k}, wherein n_{CCE,0} is the starting CCE index indicated by the assistance information for the first UE, such as k=0.

For example, assistance information can indicate a number N of PDCCHs for which the UE is provided monitoring/reception information, such as CCE indexes or PDCCH candidates indexes for a subsequent N configured PDCCH receptions. In another example, such number N can be provided by higher layers or can be predetermined in the specifications of system operation.

In various example, a reference PDCCH can refer to a PDCCH for a first/earliest slot or MO, or a first/smallest index scheduled cell (or set of cells), or a first/smallest index search space set, and so on. For example, ordering of PDCCHs among the multiple PDCCHs indicated by assistance information can be in acceding or descending order of slot index or scheduled cell (or cell set) index or search space set index, and so on. For example, the specifications of system information or higher layer configuration can indicate which metric from the previous metrics is used for ordering of the different PDCCHs indicated by assistance information. In another example, such metric can be indicated by the assistance information, such as by a 1-bit or 2-bit flag in the assistance information, e.g., value 0 or 00 referring to ordering with respect to slot index, value 1 or 01 referring to ordering with respect to scheduled cell index (or cell set index), value 10 referring to ordering with respect to search space set index, and so on. In another example, higher layer configuration or a flag (e.g., 1-bit flag) in the assistance information can indicate whether the ordering is in ascending order or descending order, or such ordering can be predetermined in the specifications of system operation.

Similar methods can be used for ordering of assistance information corresponding to multiple PDCCHs associated with different DL/UL link directions, or beam/TRP/TCI, and so on. For example, assistance information can provide monitoring information for a pair of PDCCHs, wherein a first PDCCH is for scheduling a DL reception/PDSCH and a second PDCCH is for scheduling an UL transmission/PUSCH.

Fallback: In one example, assistance information can indicate a fallback to full blind decoding. For example, assistance information can include a reserved value, such as all zeros or all 1s, that indicates the current L1/L2 signaling does not provide any assistance information, and the UE may perform blind decoding without any assistance information. In another example, such fallback can be indicated using a 1-bit flag at the beginning of the assistance information. For example, assistance information is provided and present when the flag indicates a first value (e.g., 1) and is absent/not provided or reserved when the flag indicates a second value (e.g., 0).

In another example, fallback applies when certain conditions are not satisfied or not determined for the subsequent PDCCH reception. For example, assistance information applies only when the subsequent PDCCH reception corresponds to one or more of: same CORESET, same search space, same AL, same scheduled cell, next slot, as a first PDCCH that provides or schedules the assistance information. For example, when one or more of these conditions do not apply (for example, as indicated by corresponding fields), the UE falls back to full blind decoding.

### Signaling of Assistance Information For Reduced Blind Decoding

In some embodiments, the UE can receive the assistance information for reduced blind decoding via L1 (or L2) signaling, including a first scheduling DCI format for subsequent one or more second DCI formats, or a standalone DCI format, such as a UE-specific or group-common DCI format (in a USS set or a CSS set), or a MAC-CE command, for a number of subsequent PDCCH receptions.

In one example, a UE receives a first DCI format in a first PDCCH reception, wherein the first DCI format schedules a first PDSCH reception or a first PUSCH transmission in a first slot on a first serving cell. The first DCI format includes one or multiple fields that provide assistance-information, as previously described, for one or more subsequent PDCCH receptions. The one or more fields can be referred to as PDCCH assistance information (PAI) fields.

In one example, the UE can receive a standalone DCI format in a CSS set or a USS set that provides the assistance information, as previously described, for subsequent PDCCH receptions. For example, the UE can be configured a positionInDCI and a number of bits to determine a block of information from the standalone DCI format that provides the assistance information for the UE. For example, the standalone DCI provides multiple blocks of assistance information for multiple UEs (e.g., with standalone DCI monitored in a CSS set that can be considered as a UE-group-common DCI format). For example, the standalone PDCCH does not schedule a PDSCH or PUSCH. For example, the UE can receive higher layer configuration for an RNTI (such as PAI-RNTI) for monitoring the standalone DCI format in the CSS set. For example, the UE can receive the RNTI using system information or using cell-specific/UE-common/UE-group-common higher layer configuration. For example, the standalone DCI format can be a same DCI format that is used for other purposes, such as for slot format indication or system parameter indication and so on.

In another example, multiple blocks of a standalone DCI can correspond to a same UE (still in a CSS set), or the whole standalone can correspond to a single UE (for example, standalone DCI monitored in a USS set). For example, different blocks can provide different assistance information for different subsequent PDCCH receptions, as previously described. For example, the UE can monitor the standalone DCI format using C-RNTI or MCS-C-RNTI or CS-RNTI, or using a different RNTI that is configured to the UE. For example, when the UE monitors a GC-DCI format providing assistance information in a CSS set, the UE can determine a CSS set associated with the GC-DCI format based on an initialization n_RNTI=0 or an n_RNTI=PAI-RNTI or other RNTI that is used for scrambling a CRC of the GC-DCI format that provides the assistance information.

For example, a size of the standalone DCI format can be configured by higher layers or can be predetermined to be same as another DCI format, such as a fallback DCI format 0_0/1_0 or a configured DCI format with a largest DCI size. In another example, the UE can determine a size of the standalone DCI format based on configuration of corresponding parameters, such as number of blocks and number of bits in each information block.

In another example, assistance information can be provided as a DL MAC-CE that is included in a PDSCH. In another example, assistance information can be provided as DL L1 control information that is multiplexed in a PDSCH.

### Other UE Procedures for Reduced Blind Decoding

Additional UE procedures can apply regarding assistance information and reduced blind decoding, such as overriding assistance info, or HARQ-ACK feedback for assistance information.

In one example, when a UE receives first assistance information for a subsequent PDCCH reception with a given slot offset, for example, N slots, the UE can then receive second assistance information (in a later slot) for the same subsequent PDCCH reception in the corresponding slot that override the assistance information. For example, the second assistance information can cancel the previous indication, therefore the UE performs full blind decoding for the corresponding PDCCH reception without any assistance information. For example, the second assistance information can include a flag that indicates no assistance information for a same slot/MO (and possibly same CORESET/search space set, and so on) as that indicated in the first assistance information. In another example, the second assistance information can update one or more of the parameters, such as BD/CCE information, for the corresponding subsequent PDCCH reception.

In one example, the gNB has the flexibility to transmit PDCCH in second CCEs or in a second PDCCH candidate that are different from first CCEs or a first PDCCH candidate that was indicated by (previous) assistance information. For example, when a UE attempts to receive PDCCH in the first CCEs or PDCCH candidate that was indicated by the (previous) assistance information, the UE continues to perform full blind decoding to monitor and receive PDCCH in the corresponding slot/MO.

In one example, the UE provides HARQ-ACK feedback in response to receiving an L1/L2 signaling that provides the assistance information, such as when the assistance information is provided by a standalone DCI format without scheduling a PDSCH reception or a PUSCH transmission.

In one example, the UE can receive separate PDCCH skipping for DL DCI format and UL DCI formats. For example, the UE can receive separate PDCCH skipping for first USS sets configured for DL DCI formats and second USS sets configured for UL DCI formats (and third USS sets configured for both DL/UL DCI formats). For example, the UE can be indicated to apply PDDCH skipping only to some USS sets (or some DCI formats), such as only second USS set (or DCI formats) and no PDCCH skipping for first/third USS sets (or DCI formats), or to apply different time duration for PDCCH skipping for first and second and third USS sets (or DCI formats). For example, the UE applies such PDCCH skipping for operation of the UE in either IDLE/INACTIVE state or in CONNECTED state.

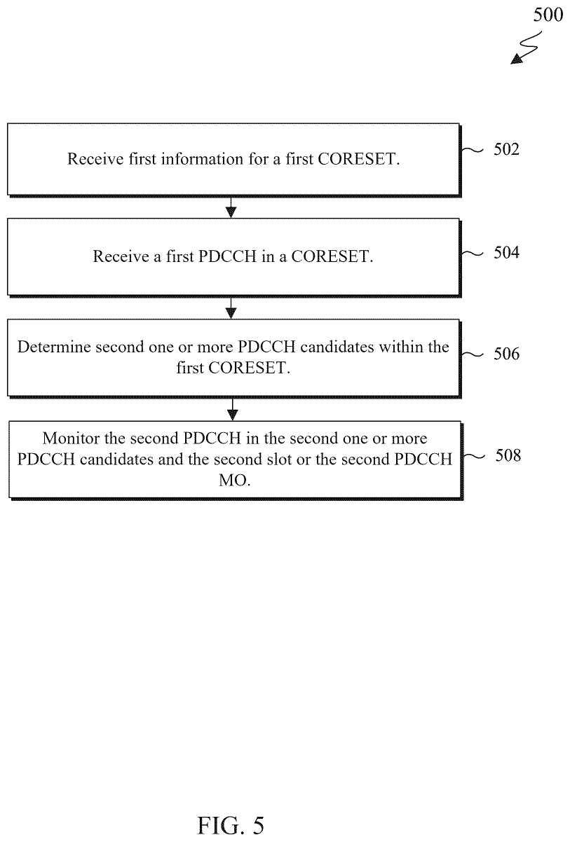

FIG. 5 illustrates a flowchart of a method 500 performed by a UE in a wireless communication process. The method 500 may be performed by any of the UEs, such as, UE 116 in FIG. 1, and a corresponding method may be performed by a base station, such as, gNB 102 in FIG. 1. The method 500 is by way of example and is not a limitation on the embodiments that can be implemented in accordance with the present disclosure.

The method 500 begins with the UE receiving first information for a first CORESET (502). The UE then receives a first PDCCH in a CORESET (504). For example, in 504, the reception of the PDCCH is in a first slot or a first PDCCH MO. In various embodiments, the first PDCCH provides a first DCI format; the first DCI format includes PAI associated with a second PDCCH in a second slot or a second PDCCH MO; the CORESET is the first CORESET or a second CORESET.

The UE then determines second one or more PDCCH candidates within the first CORESET (506). For example, in 506 the determination is based on the PAI. The UE then monitors the second PDCCH in the second one or more PDCCH candidates and the second slot or the second PDCCH MO (508).

In various embodiments, the second one or more PDCCH candidates have one or more respective starting CCEs and an AL of L CCEs. The one or more respective starting CCEs are from first CCEs that comprise the first CORESET and are indicated by the PAI. A value L of the AL is same as a value of an AL for the first PDCCH or is indicated by the PAI.

In various embodiments, the second one or more PDCCH candidates have one or more respective indexes indicated by the PAI and are according to a second search space set associated with the first CORESET. The second search space set is same as a first search space set, associated with the first CORESET, for monitoring the first PDCCH when the first PDCCH is received in the first CORESET or has an index that is indicated by the PAI.

In various embodiments, the PAI indicates an index of the first CORESET, or an index of a group of CORESETs that includes the first CORESET, when the first PDCCH is received in the second CORESET.

In various embodiments, the second slot is an earliest slot for PDCCH monitoring after the first slot, the second MO is an earliest MO for PDCCH monitoring after the first MO, or the PAI indicates an index of the second slot or the second MO, an offset of the second slot or the second MO relative to the first slot or the first MO, or an offset of the second slot or the second MO relative to an ending slot of a processing time duration after the first slot or the first MO.

In various embodiments, the first DCI format schedules a PDSCH or a PUSCH and the PAI is provided by one or more fields in the first DCI format.

In various embodiments, the UE receives second information for a bit-position in payload of the first DCI format or an index of an information block in the first DCI format and a RNTI associated with the first DCI format. The first DCI format does not schedule a PDSCH or a PUSCH, the first DCI format has a CRC that is scrambled by the RNTI, the first DCI format includes a number of information blocks, and the PAI is provided by an information block, from the number of information blocks, starting at the bit-position or corresponding to the index.

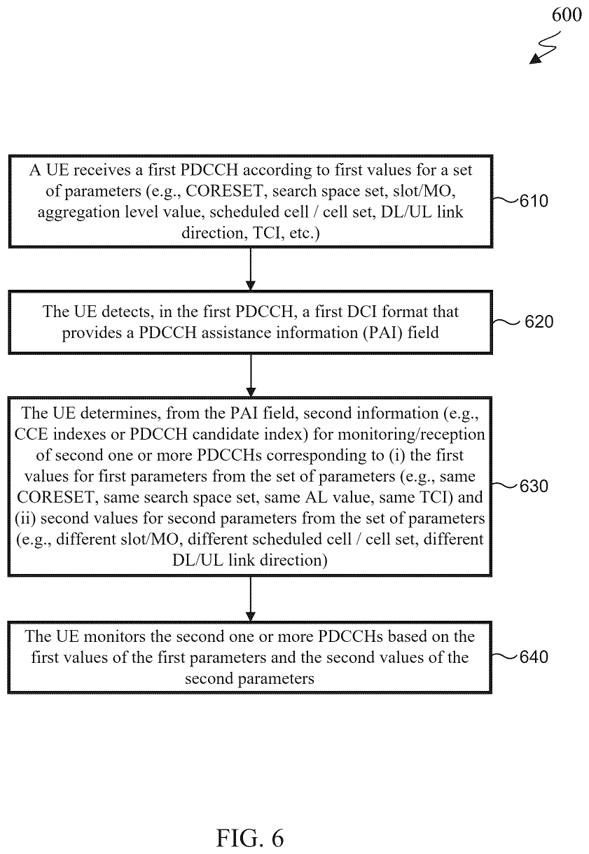

FIG. 6 illustrates a flowchart of a method 600 of providing assistance-information for monitoring one or multiple subsequent PDCCHs. The method 600 may be performed by any of the UEs, such as, UE 116 in FIG. 1, and a corresponding method may be performed by a base station, such as, gNB 102 in FIG. 1. The method 600 is by way of example and is not a limitation on the embodiments that can be implemented in accordance with the present disclosure.

The UE receives a first PDCCH according to first values for a set of parameters (e.g., CORESET, search space set, slot/MO, aggregation level value, scheduled cell/cell set, DL/UL link direction, TCI, etc.) (610). The UE detects, in the first PDCCH, a first DCI format that provides a PDCCH assistance information (PAI) field (620). The UE determines, from the PAI field, second information (e.g., CCE indexes or PDCCH candidate index) for monitoring/reception of second one or more PDCCHs corresponding to (i) the first values for first parameters from the set of parameters (e.g., same CORESET, same search space set, same AL value, same TCI) and (ii) second values for second parameters from the set of parameters (e.g., different slot/MO, different scheduled cell/cell set, different DL/UL link direction) (630). The UE monitors the second one or more PDCCHs based on the first values of the first parameters and the second values of the second parameters (640).

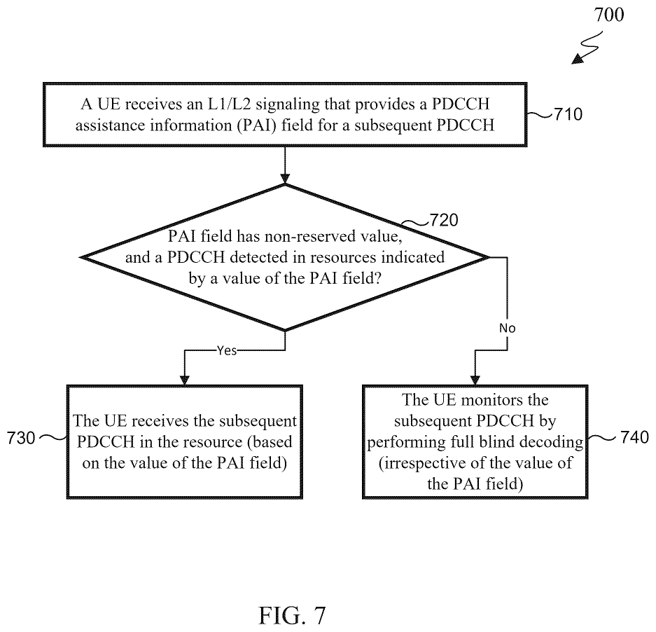

FIG. 7 illustrates a flowchart of a method 700 for fallback from PDCCH monitoring based on assistance information to PDCCH monitoring with full blind decoding. The method 700 may be performed by any of the UEs, such as, UE 116 in FIG. 1, and a corresponding method may be performed by a base station, such as, gNB 102 in FIG. 1. The method 700 is by way of example and is not a limitation on the embodiments that can be implemented in accordance with the present disclosure.

A UE receives an L1/L2 signaling that provides a PDCCH assistance information (PAI) field for a subsequent PDCCH (710). The UE determines whether PAI field has a non-reserved value, and a PDCCH is detected in resources indicated by a value of the PAI field (720). If the UE makes such determination, the UE receives the subsequent PDCCH in the resource (based on the value of the PAI field) (730). Otherwise (i.e., if the UE determines that PAI field has a reserved value, or a PDCCH is not detected in resources indicated by the value of the PAI field), the UE monitors the subsequent PDCCH by performing full blind decoding (irrespective of the value of the PAI field) (740).

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information for a first control resource set (CORESET);
receiving a first physical downlink control channel (PDCCH) in a CORESET, wherein:
the reception of the first PDCCH is in a first slot or a first PDCCH monitoring occasion (MO),
the first PDCCH provides a first downlink control information (DCI) format,
the first DCI format includes PDCCH assistance information (PAI) associated with a second PDCCH in a second slot or a second PDCCH MO, and
the CORESET is the first CORESET or a second CORESET;
determining, based on the PAI, second one or more PDCCH candidates within the first CORESET; and
monitoring the second PDCCH in (i) the second one or more PDCCH candidates and (ii) the second slot or the second PDCCH MO.

2. The method of claim 1, wherein:
the second one or more PDCCH candidates have (i) one or more respective starting control channel elements (CCEs) and (ii) an aggregation level (AL) of L CCEs,
the one or more respective starting CCEs:
are from first CCEs that comprise the first CORESET, and
are indicated by the PAI, and
a value L of the AL (i) is same as a value of an AL for the first PDCCH or (ii) is indicated by the PAI.

3. The method of claim 1, wherein:
the second one or more PDCCH candidates:
have one or more respective indexes indicated by the PAI, and
are according to a second search space set associated with the first CORESET, and
the second search space set (i) is same as a first search space set, associated with the first CORESET, for monitoring the first PDCCH when the first PDCCH is received in the first CORESET or (ii) has an index that is indicated by the PAI.

4. The method of claim 1, wherein the PAI indicates an index of the first CORESET, or an index of a group of CORESETs that includes the first CORESET, when the first PDCCH is received in the second CORESET.

5. The method of claim 1, wherein:
the second slot is an earliest slot for PDCCH monitoring after the first slot,
the second MO is an earliest MO for PDCCH monitoring after the first MO, or the PAI indicates:
an index of the second slot or the second MO,
an offset of the second slot or the second MO relative to the first slot or the first MO, or
an offset of the second slot or the second MO relative to an ending slot of a processing time duration after the first slot or the first MO.

6. The method of claim 1, wherein:
the first DCI format schedules a physical downlink shared channel (PDSCH) or a physical uplink shared channel (PUSCH), and
the PAI is provided by one or more fields in the first DCI format.

7. The method of claim 1, further comprising:
receiving second information for:
a bit-position in payload of the first DCI format or an index of an information block in the first DCI format, and
a radio network temporary identifier (RNTI) associated with the first DCI format,
wherein:
the first DCI format does not schedule a physical downlink shared channel (PDSCH) or a physical uplink shared channel (PUSCH),
the first DCI format has a cyclic redundancy check (CRC) that is scrambled by the RNTI,
the first DCI format includes a number of information blocks, and
the PAI is provided by an information block, from the number of information blocks, starting at the bit-position or corresponding to the index.

8. A user equipment (UE) comprising:
a transceiver configured to:
receive first information for a first control resource set (CORESET); and
receive a first physical downlink control channel (PDCCH) in a CORESET, wherein:
the reception of the first PDCCH is in a first slot or a first PDCCH monitoring occasion (MO),
the first PDCCH provides a first downlink control information (DCI) format,
the first DCI format includes PDCCH assistance information (PAI) associated with a second PDCCH in a second slot or a second PDCCH MO, and
the CORESET is the first CORESET or a second CORESET; and
a processor operably coupled with the transceiver, the processor configured to determine, based on the PAI, second one or more PDCCH candidates within the first CORESET,
wherein the transceiver is further configured to monitor the second PDCCH in (i) the second one or more PDCCH candidates and (ii) the second slot or the second PDCCH MO.

9. The UE of claim 8, wherein:
the second one or more PDCCH candidates have (i) one or more respective starting control channel elements (CCEs) and (ii) an aggregation level (AL) of L CCEs,
the one or more respective starting CCEs:
are from first CCEs that comprise the first CORESET, and
are indicated by the PAI, and
a value L of the AL (i) is same as a value of an AL for the first PDCCH or (ii) is indicated by the PAI.

10. The UE of claim 8, wherein:
the second one or more PDCCH candidates:
have one or more respective indexes indicated by the PAI, and
are according to a second search space set associated with the first CORESET, and
the second search space set (i) is same as a first search space set, associated with the first CORESET, for monitoring the first PDCCH when the first PDCCH is received in the first CORESET or (ii) has an index that is indicated by the PAI.

11. The UE of claim 8, wherein the PAI indicates an index of the first CORESET, or an index of a group of CORESETs that includes the first CORESET, when the first PDCCH is received in the second CORESET.

12. The UE of claim 8, wherein:
the second slot is an earliest slot for PDCCH monitoring after the first slot,
the second MO is an earliest MO for PDCCH monitoring after the first MO, or
the PAI indicates:
an index of the second slot or the second MO,
an offset of the second slot or the second MO relative to the first slot or the first MO, or
an offset of the second slot or the second MO relative to an ending slot of a processing time duration after the first slot or the first MO.

13. The UE of claim 8, wherein:
the first DCI format schedules a physical downlink shared channel (PDSCH) or a physical uplink shared channel (PUSCH), and
the PAI is provided by one or more fields in the first DCI format.

14. The UE of claim 8, wherein:
the transceiver is further configured to receive second information for:
a bit-position in payload of the first DCI format or an index of an information block in the first DCI format, and
a radio network temporary identifier (RNTI) associated with the first DCI format;
the first DCI format does not schedule a physical downlink shared channel (PDSCH) or a physical uplink shared channel (PUSCH);
the first DCI format has a cyclic redundancy check (CRC) that is scrambled by the RNTI;
the first DCI format includes a number of information blocks; and
the PAI is provided by an information block, from the number of information blocks, starting at the bit-position or corresponding to the index.

15. A base station comprising:
a transceiver configured to:
transmit first information for a first control resource set (CORESET); and
transmit a first physical downlink control channel (PDCCH), in a CORESET, wherein:
the reception of the first PDCCH is in a first slot or a first PDCCH monitoring occasion (MO),
the first PDCCH provides a first downlink control information (DCI) format,
the first DCI format includes PDCCH assistance information (PAI) associated with a second PDCCH in a second slot or a second PDCCH MO, and
the CORESET is the first CORESET or a second CORESET; and
a processor operably coupled with the transceiver, the processor configured to determine, based on the PAI, second one or more PDCCH candidates within the first CORESET;
wherein the transceiver is further configured to transmit the second PDCCH in (i) a PDCCH candidate from the second one or more PDCCH candidates and (ii) the second slot or the second PDCCH MO.

16. The base station of claim 15, wherein:
the second one or more PDCCH candidates have (i) one or more respective starting control channel elements (CCEs) and (ii) an aggregation level (AL) of L CCEs,
the one or more respective starting CCEs:
are from first CCEs that comprise the first CORESET, and
are indicated by the PAI, and
a value L of the AL (i) is same as a value of an AL for the first PDCCH or (ii) is indicated by the PAI.

17. The base station of claim 15, wherein:
the second one or more PDCCH candidates:
have one or more respective indexes indicated by the PAI, and
are according to a second search space set associated with the first CORESET, and
the second search space set: (i) is same as a first search space set, associated with the first CORESET, for monitoring the first PDCCH when the first PDCCH is received in the first CORESET or (ii) has an index that is indicated by the PAI.

18. The base station of claim 15, wherein the PAI indicates an index of the first CORESET, or an index of a group of CORESETs that includes the first CORESET, when the first PDCCH is received in the second CORESET.

19. The base station of claim 15, wherein:
the second slot is an earliest slot for PDCCH monitoring after the first slot,
the second MO is an earliest MO for PDCCH monitoring after the first MO, or
the PAI indicates:
an index of the second slot or the second MO,
an offset of the second slot or the second MO relative to the first slot or the first MO, or
an offset of the second slot or the second MO relative to an ending slot of a processing time duration after the first slot or the first MO.

20. The base station of claim 15, wherein:
the first DCI format schedules a physical downlink shared channel (PDSCH) or a physical uplink shared channel (PUSCH), and the PAI is provided by one or more fields in the first DCI format; or
the first DCI format does not schedule a PDSCH or a PUSCH, and the PAI is provided by an information block in the first DCI format that starts at a bit-position indicated by higher layers.
